(19) United States
(12) Patent Application Publication
(10) Pub. No.: US 2025/0304749 A1
(43) Pub. Date: Oct. 2, 2025

(54) POLYAMIC ACID-CONTAINING LIQUID AND METHOD FOR PRODUCING POLYAMIC ACID CONTAINING LIQUID

(71) Applicant: Resonac Corporation, Tokyo (JP)

(72) Inventors: Tomoaki MAENO, Tokyo (JP); Yasunori KAWABATA, Tokyo (JP); Tomoya HIGASHIHARA, Yamagata (JP)

(21) Appl. No.: 18/861,767

(22) PCT Filed: May 9, 2022
(86) PCT No.: PCT/JP2022/019740

§ 371 Date: Oct. 30, 2024

(51) Int. Cl. C08G 73/10

(52) U.S. Cl. CPC C08G 73/1082; C08G 73/1028; C08G 73/1042

(57) ABSTRACT

The disclosure relates to a method for producing a polyamic acid-containing liquid, including obtaining a polyamic acid-containing liquid that contains a polyamic acid, by using a prepolymer-containing liquid containing an amic acid prepolymer, a diamine, and a tetracarboxylic dianhydride.

### FIELD

Embodiments of the present invention relate to a method for producing a polyamic acid-containing liquid; a polyamic acid-containing liquid; and a method for producing a polyimide, a compact, and a printed board.

### BACKGROUND

Since polyimides have high heat resistance, chemical resistance, high mechanical properties, and a low permittivity, they are widely used in the fields of automobiles, electronic components, displays, and the like. For example, semi-aromatic polyimides having a structure derived from an aliphatic or alicyclic diamine and a structure derived from an aromatic tetracarboxylic dianhydride, or semi-aromatic polyimides having a structure derived from an aromatic diamine and an aliphatic or alicyclic acid dianhydride are expected to be applied to high frequency antennas, substrates such as flexible printed boards (FPCs), coil insulation coatings for inverter drive motors which are becoming increasingly high frequency and high voltage, and the like.

Patent Literature 1 discloses a solvent-insoluble polyimide film where a dimer diamine is used in an amount of more than 15% by mol and less than 50% by mol relative to the total diamine component. Patent Literature 1 also discloses that a polyamic acid liquid can be obtained as an optically uniform solution by, for example, blending a tetracarboxylic dianhydride with a diamine in approximately equimolar proportions in a nitrogen-containing polar solvent, and conducting a polymerization at 10° C. to 70° C.

### CITATION LIST

### Patent Literature

Patent Literature 1: JP 2020-76072 A

### SUMMARY

### Technical Problem

The present disclosure provides a method for easily producing a polyamic acid-containing liquid from which a polyimide exhibiting excellent permittivity properties can be obtained. The present disclosure also provides a polyamic acid-containing liquid from which a polyimide exhibiting excellent permittivity properties can be obtained, and which exhibits excellent film-forming properties. Further, the present disclosure provides a method for producing a polyimide, a compact, and a printed board that exhibit excellent permittivity properties.

### Solution to Problem

Examples of embodiments are listed below. The present invention is not limited to the following embodiments.

One embodiment relates to a method for producing a polyamic acid-containing liquid including obtaining a polyamic acid-containing liquid that contains a polyamic acid, by using a prepolymer-containing liquid that contains an amic acid prepolymer including a structure derived from an aromatic diamine and a structure derived from a tetracarboxylic dianhydride, an aliphatic or alicyclic diamine, and a tetracarboxylic dianhydride.

Another embodiment relates to a method for producing a polyamic acid-containing liquid including obtaining a polyamic acid-containing liquid that contains a polyamic acid, by using a prepolymer-containing liquid that contains an amic acid prepolymer including a structure derived from an aliphatic or alicyclic diamine and a structure derived from a tetracarboxylic dianhydride, a diamine, and a tetracarboxylic dianhydride.

Another embodiment relates to a polyamic acid-containing liquid including a polyamic acid including a structure derived from an aliphatic or alicyclic diamine and a structure derived from a tetracarboxylic dianhydride, and a solvent; and satisfying one or both of (1) and (2) below:
(1) a content of a component derived from an amine and a carboxylic anhydride is 20.0% by mass or more, and a turbidity is 2.5 NTU or less; and
(2) a content of the polyamic acid is 20.0% by mass or more relative to a total mass of the polyamic acid and the solvent.

Another embodiment relates to a polyamic acid-containing liquid including a polyamic acid including a structure derived from an aliphatic or alicyclic diamine and a structure derived from a tetracarboxylic dianhydride, and a solvent; and satisfying one or both of (3) and (4) below:
(3) a turbidity is 2.5 NTU or less; and a mass ratio of a component derived from an amine and a carboxylic anhydride, obtained by heating the polyamic acid-containing liquid, relative to a mass of the polyamic acid-containing liquid is 18.0% by mass or more; and
(4) a mass ratio of a polyimide obtained by heating a filtrate of the polyamic acid-containing liquid, relative to a mass of the polyamic acid-containing liquid is 18.0% by mass or more.

Some other embodiments relate to the above-described polyamic acid-containing liquid, for an insulating material use, a heat-resistant insulating material use, or a printed board use.

Some other embodiments relate to a method for producing a polyimide, a compact, and a printed board, by using the above-described polyamic acid-containing liquid.

### Advantageous Effects of Invention

According to the present disclosure, it is possible to provide a method for easily producing a polyamic acid-containing liquid from which a polyimide exhibiting excellent permittivity properties can be obtained. According to the present disclosure, it is also possible to provide a polyamic acid-containing liquid from which a polyimide exhibiting excellent permittivity properties can be obtained and which exhibits excellent film-forming properties. Further, according to the present disclosure, it is possible to provide a method for producing a polyimide, a compact, and a printed board that exhibit excellent permittivity properties.

### DESCRIPTION OF EMBODIMENTS

Embodiments of the present invention will be described. The present invention is not limited to the following embodiments. The following embodiments can be implemented alone or in combination. Combinations of multiple embodiments are also included in the present invention.

In numerical ranges described step by step in the present disclosure, an upper or lower limit of a numerical range may be replaced with an upper or lower limit of another numerical range. An upper or lower limit of a numerical range described in the present disclosure may be replaced with a value indicated in examples. A certain numerical value may be selected from the upper limit numerical values described step by step in the present disclosure, and a certain numerical value may be selected from the lower limit numerical values described step by step in the present disclosure, to form another step by step numerical range. An upper limit numerical value and a lower limit numerical value described in the present disclosure may be replaced with values indicated in examples.

In the present disclosure, each component may include multiple types of substances corresponding therewith. When there are multiple types of substances corresponding with each component in a composition, the content or amount contained of each component means, unless otherwise specified, the total content or the total amount contained of the multiple types of substances present in the composition.

In the present disclosure, each structure in a polymer may include multiple types of structures corresponding therewith. When there are multiple types of structures corresponding with each structure in a polymer, the content or amount contained of each structure means, unless otherwise specified, the total content or the total amount contained of the multiple types of structures present in the polymer.

In the present disclosure, the term “step” includes, in addition to a step that is independent of other steps, also a step that cannot be clearly distinguished from other steps, provided that a desired action of the step is achieved.

In the present disclosure, the term “layer” includes a layer formed only in a portion of a region, in addition to a layer formed over the entire region, when the region where the layer is present is observed.

### <Method for Producing Polyamic Acid-Containing Liquid>

A method for producing a polyamic acid-containing liquid includes obtaining a polyamic acid-containing liquid that contains a polyamic acid, by using a prepolymer-containing liquid that contains an amic acid prepolymer, a diamine, and a tetracarboxylic dianhydride.

In some embodiments, a method for producing a polyamic acid-containing liquid includes obtaining a polyamic acid-containing liquid that contains a polyamic acid, by using a prepolymer-containing liquid that contains an amic acid prepolymer including a structure derived from an aromatic diamine and a structure derived from a tetracarboxylic dianhydride, an aliphatic or alicyclic diamine, and a tetracarboxylic dianhydride. In the present disclosure, the production method may be referred to as “production method R”.

In some other embodiments, a method for producing a polyamic acid-containing liquid includes obtaining a polyamic acid-containing liquid that contains a polyamic acid, by using a prepolymer-containing liquid that contains an amic acid prepolymer including a structure derived from an aliphatic or alicyclic diamine and a structure derived from a tetracarboxylic dianhydride, a diamine, and a tetracarboxylic dianhydride. In the present disclosure, the production method is sometimes referred to as “production method L”.

A polyamic acid is usually synthesized through addition condensation—that is, polymerization of a diamine and a tetracarboxylic dianhydride. In polymerization of an aromatic diamine and a tetracarboxylic dianhydride, reaction generally proceeds easily at room temperature. However, in polymerization of a diamine including an aliphatic or alicyclic diamine and a tetracarboxylic dianhydride, there is an issue that the reaction is unlikely to proceed due to formation of a precipitate. Basicity of an aliphatic or alicyclic diamine is much higher than that of an aromatic diamine. The precipitate is thought to include a salt formed by an unreacted aliphatic or alicyclic diamine, which exhibits high basicity, and a carboxylic acid (i.e., a ring-opened carboxylic dianhydride) generated during addition condensation or a polyamic acid having a carboxyl group obtained through the addition condensation.

In the present disclosure, even when a diamine includes an aliphatic or alicyclic diamine, it is possible to advance the reaction by suppressing formation of the salt, dissolving the formed salt, or both, with a simple operation of using an amic acid prepolymer, a diamine, and a tetracarboxylic dianhydride. Thus, it is possible to easily produce a polyamic acid-containing liquid that contains a polyamic acid including a structure derived from an aliphatic or alicyclic diamine. According to some embodiments, it is possible to produce a polyamic acid-containing liquid that contains a polyamic acid at a high concentration in a short time.

### [Production Method R]

The production method R includes obtaining a polyamic acid-containing liquid that contains a polyamic acid by using a prepolymer-containing liquid that contains an amic acid prepolymer including a structure derived from an aromatic diamine and a structure derived from a tetracarboxylic dianhydride, an aliphatic or alicyclic diamine, and a tetracarboxylic dianhydride (in the present disclosure, sometimes referred to as “step R2”). The production method R can further include preparing a prepolymer-containing liquid that contains an amic acid prepolymer including a structure derived from an aromatic diamine and a structure derived from a tetracarboxylic dianhydride (in the present disclosure, sometimes referred to as “step R1”). In the present disclosure, a tetracarboxylic dianhydride may be referred to as “acid dianhydride”. In the present disclosure, an amic acid prepolymer that includes a structure derived from an aromatic diamine and a structure derived from a tetracarboxylic dianhydride may be referred to as “aromatic prepolymer”, and a prepolymer-containing liquid that contains an aromatic prepolymer may be referred to as “aromatic prepolymer-containing liquid”. The production method R may include an optional step other than steps R1 and R2.

In the production method R, polymerization can proceed even when an aliphatic or alicyclic diamine is used. One of the reasons is presumed as follows. In the production method R, a polyamic acid is obtained by reacting an aromatic prepolymer, an aliphatic or alicyclic diamine, and an acid dianhydride. The aliphatic or alicyclic diamine forms a salt with each of the aromatic prepolymer and the acid dianhydride. When the composition ratio of the polyamic acid to be obtained is the same, in the production method R, a salt of the aliphatic or alicyclic diamine with the aromatic prepolymer is formed, and thus the amount of a salt of the aliphatic or alicyclic diamine with the acid dianhydride is reduced as compared with the case where the polyamic acid is obtained using the aromatic diamine and the aliphatic or alicyclic diamine with the acid dianhydride. The salt of the aromatic prepolymer dissolves more easily than the salt of the acid dianhydride due to structural effects. In the production method R, the salt of the aromatic prepolymer, which easily dissolves, is formed, and formation of the salt of the acid dianhydride, which is unlikely to dissolve, is suppressed. In other words, the production method R is a method to promote the dissolution of the entire salt by reducing a salt which is poorly soluble and including a salt which is easily soluble, thereby advancing the polymerization reaction. However, the present invention is not limited by this presumption.

In step R1, an aromatic prepolymer-containing liquid is prepared. In some embodiments, step R1 may be to prepare an aromatic prepolymer-containing liquid by using a previously produced prepolymer-containing liquid that contains an amic acid prepolymer including a structure derived from an aromatic diamine, and a structure derived from an acid dianhydride (step R1-s). Alternatively, in some embodiments, step R1 may be to obtain an aromatic prepolymer-containing liquid that contains an aromatic prepolymer by using an aromatic diamine, an acid dianhydride, and a solvent (step R1-i).

In step R2, a polyamic acid-containing liquid is obtained using the aromatic prepolymer-containing liquid, an aliphatic or alicyclic diamine, and an acid dianhydride. An aromatic diamine may be further used. For example, step R2 may be to obtain a polyamic acid-containing liquid that contains a polyamic acid by adding an aliphatic or alicyclic diamine and an acid dianhydride to the aromatic prepolymer-containing liquid (step R2-a). An aliphatic or alicyclic diamine, an acid dianhydride, and further an aromatic diamine may be added to the aromatic prepolymer-containing liquid. In a method where only one of the aliphatic or alicyclic diamine and the acid dianhydride is added to the aromatic prepolymer-containing liquid, polymerization reaction is unlikely to proceed because it is easily affected by moisture existing in the reaction system or a poorly soluble salt is easily formed.

Embodiments of the production method R include, for example, a production method Rs including steps R1-s and R2-a, and a production method Ri including steps R1-i and R2-a. In the production method Ri, step R2-a is preferably performed consecutively to step R1-i.

In step R1-s, for example, a previously produced prepolymer-containing liquid that contains an amic acid prepolymer including a structure derived from an aromatic diamine and a structure derived from an acid dianhydride can be an aromatic prepolymer-containing liquid to be used in step R2 as it is. Alternatively, in step R1-s, for example, a previously produced prepolymer-containing liquid can be diluted or concentrated as necessary to adjust the concentration thereof to obtain an aromatic prepolymer-containing liquid to be used in step R2. The previously produced prepolymer-containing liquid to be used in step R1-s may be, for example, a separately produced prepolymer-containing liquid, or a commercially available prepolymer-containing liquid. The prepolymer-containing liquid can be produced using a known method for producing a polyamic acid solution, a method for producing a polyamic acid-containing liquid according to the disclosure, or the like.

As step R1-i, for example, the following method can be given. First, an aromatic diamine is dissolved in a solvent to prepare an aromatic diamine solution. Next, an acid dianhydride is added to the aromatic diamine solution and stirred. The stirring time is, for example, within a range from 5 minutes to 5 hours, from 10 minutes to 3 hours, or from 30 minutes to 2 hours. The stirring temperature is, for example, within a range from 10° C. to 50° C., from 15° C. to 40° C., or from 20° C. to 35° C.

The total amount of the acid dianhydride may be added to the aromatic diamine solution all at once, or the total amount of the acid dianhydride may be added to the aromatic diamine solution in two or more portions. The number of portions may be, for example, 10 or less, 7 or less, or 4 or less. The time interval between each addition may be, for example, 5 minutes or more, or 10 minutes or more. The time interval may be, for example, 120 minutes or less, 60 minutes or less, 30 minutes or less, or 15 minutes or less.

Since an aromatic diamine has low basicity, it is unlikely to form a salt with an acid dianhydride. Thus, in step R1-i, an aromatic prepolymer-containing liquid that contains an aromatic prepolymer at a high concentration can be easily prepared.

As step R2-a, for example, the following method can be given. First, an aliphatic or alicyclic diamine is dissolved in a solvent to prepare an aliphatic or alicyclic diamine solution. Next, the aliphatic or alicyclic diamine solution and an acid dianhydride are added to the aromatic prepolymer-containing liquid prepared in step R1, and stirred. The stirring time is, for example, 10 minutes or more, 1 hour or more, or 3 hours or more. The stirring time is, for example, 72 hours or less, 48 hours or less, 24 hours or less, 12 hours or less, or 5 hours or less. The stirring temperature is, for example, within a range from 10° C. to 50° C., from 15° C. to 40° C., or from 20° C. to 35° C. When a stirrer is used for stirring, the rotational speed is, for example, within a range from 50 to 2,000 min-1, from 200 to 1,000 min-1, or from 300 to 800 min-1.

Although depending on the amount of the aromatic prepolymer, the amount added of the aliphatic or alicyclic diamine and the acid dianhydride, the method of addition, and the like, a salt usually precipitates through addition. Stirring time is preferably equal to or longer than time required to dissolve the salt. In contrast, from the viewpoint of production efficiency, the stirring time is preferably short. In the production method R, since the salt can dissolve in a short time, the polyamic acid-containing liquid can be efficiently produced. The salt can dissolve in a short time as the stirring temperature is higher. Thus, the stirring may be performed while heating. In contrast, from the viewpoint of easy production, stirring is preferably performed without heating. In the production method R, since a salt can dissolve in a short time without heating, polyamic acid can be efficiently produced. By using an additive capable of dissolving a salt, such as acetic acid, the salt can dissolve in a short time. Thus, stirring may be performed in the presence of an additive capable of dissolving a salt. In contrast, from the viewpoint of easy production, stirring is preferably performed without using an additive. In the production method R, since a salt can dissolve in a short time without using an additive, polyamic acid can be efficiently produced.

The aliphatic or alicyclic diamine solution and the acid dianhydride may be added simultaneously or separately to the aromatic prepolymer-containing liquid. The total amount of the aliphatic or alicyclic diamine solution, the acid dianhydride, or both may be added to the aromatic prepolymer-containing liquid in one portion, or the total amount thereof may be added to the aromatic prepolymer-containing liquid in two or more portions. If added in two or more portions, the number of portions is, for example, 10 or less, 7 or less, or 4 or less. The time interval between each addition is, for example, 5 or more minutes, or 10 or more minutes. The time interval is, for example, 120 or less, 60 or less, 30 or less, or 15 or less. Alternatively, if added in two or more portions, the number of portions is not particularly limited, and a solution may be added dropwise or a solid may be added in small amounts over a predetermined period of time. The predetermined time is, for example, within a range from 10 to 60 minutes. When both the aliphatic or alicyclic diamine solution and the acid dianhydride are added to the aromatic prepolymer-containing liquid in two or more portions, the number of portions may be the same, or may differ from each other.

An aliphatic or alicyclic diamine and an aromatic diamine may be added to the aromatic prepolymer-containing liquid. In this case, the aliphatic or alicyclic diamine and the aromatic diamine may be added simultaneously or separately to the aromatic prepolymer-containing liquid. The total amount of the aromatic diamine may be added to the aromatic prepolymer-containing liquid in one protion, or the total amount of the aromatic diamine may be added in two or more portions.

When the steps R1-i and R2-a are performed consecutively, it is preferable to start adding at least one of the aliphatic or alicyclic diamine solution and the acid dianhydride in a state where stirring in step R1-i continues, or within, for example, 60 minutes after the stirring is stopped. When the steps R1-i and R2-a are performed consecutively, the aliphatic or alicyclic diamine solution and the acid dianhydride may be added to and stirred in a container where the aromatic prepolymer-containing liquid was obtained in step R1-i.

The aromatic prepolymer may include an optional structure other than the structure derived from an aromatic diamine and a structure derived from an acid dianhydride. For example, the aromatic prepolymer can include an optional structure derived from a diamine, such as a structure derived from an aliphatic or alicyclic diamine. The content of the structure derived from an aromatic diamine is, for example, more than 50% by mass, more than 70% by mass, more than 90% by mass, or 100% by mass, relative to the total mass of the structure derived from a diamine.

A mass average molecular weight of the aromatic prepolymer is preferably within a range from 500 to 80,000, more preferably from 1,000 to 50,000, and even more preferably from 5,000 to 30,000. The mass average molecular weight may be 20,000 or less, or 10,000 or less. When the mass average molecular weight is 500 or more, a salt formed by the aromatic prepolymer and the aliphatic or alicyclic diamine tends to have low crystallinity and dissolve easily. When the mass average molecular weight is 80,000 or less, viscosity can be prevented from becoming too high, miscibility between the acid dianhydride and the aliphatic or alicyclic diamine becomes better, and the dissolution rate of the salt tends to increase easily. In the present disclosure, the mass average molecular weight can be determined by measuring with gel permeation chromatography (GPC) and converting a value using a standard polystyrene calibration curve. Specifically, the mass average molecular weight can be measured using a method described in examples.

The content of the aromatic prepolymer in the aromatic prepolymer-containing liquid is, for example, 30.0% by mass or less, 20.0% by mass or less, 12.0% by mass or less, or 8.0% by mass or less, relative to the mass of the aromatic prepolymer-containing liquid from the viewpoint of preventing viscosity from becoming too high. The content of the aromatic prepolymer is, for example, 3.0% by mass or more, 5.0% by mass or more, or 10.0% by mass or more, relative to the mass of the aromatic prepolymer-containing liquid from the viewpoint of dissolving the salt in a short time.

A mass ratio of the aromatic prepolymer used in the production method R is, for example, 10.0% by mass or more, 15.0% by mass or more, 20.0% by mass or more, 30.0% by mass or more, 40.0% or more, relative to the mass of the obtained polyamic acid from the viewpoint of dissolving the salt in a short time. The mass ratio of the aromatic prepolymer is, for example, 70.0% by mass or less, 60% by mass or less, 50% by mass or less, 40% by mass or less, or 30% by mass or less, relative to the mass of the polyamic acid in consideration of the amount used of the aliphatic or alicyclic diamine and the acid dianhydride.

When obtaining a polyamic acid-containing liquid having a particularly large content of the polyamic acid, the content of the aromatic prepolymer in the aromatic prepolymer-containing liquid is, for example, 15.0% by mass or more, 18.0% by mass or more, or 20.0% by mass or more, relative to the mass of the aromatic prepolymer-containing liquid. The content of the aromatic prepolymer is, for example, 30.0% by mass or less, or 25.0% by mass or less, relative to the mass of the aromatic prepolymer-containing liquid.

When obtaining a polyamic acid-containing liquid having a particularly large content of the polyamic acid, a mass ratio of the aromatic prepolymer used in the production method R is, for example, 50.0% by mass or more, 65.0% by mass or more, or 65.0% by mass or more, relative to the mass of the polyamic acid obtained. The mass ratio of the aromatic prepolymer is, for example, 90.0% by mass or less, 80% by mass or less, or 75.0% by mass or less, relative to the mass of the polyamic acid in consideration of the amount used of the aliphatic or alicyclic diamine and the acid dianhydride.

The polyamic acid-containing liquid obtained using the production method R usually contains a polyamic acid and a solvent. The content of the polyamic acid is not particularly limited and can be set to an appropriate content depending on application of the polyamic acid-containing liquid. In the production method R, a polyamic acid-containing liquid that contains the polyamic acid at a high content can be produced. The content of the polyamic acid may be, for example, 10.0% by mass or more, 15.0% by mass or more, 20.0% by mass or more, or 25.0% by mass or more, relative to the mass of the total mass of the polyamic acid and the solvent. The content of the polyamic acid may be, for example, 50.0% by mass or less, 40.0% by mass or less, or 30.0% by mass or less, relative to the mass of the total mass of the polyamic acid and the solvent.

The polyamic acid obtained using the production method R includes at least a structure derived from an aromatic diamine, a structure derived from an aliphatic or alicyclic diamine, and a structure derived from an acid dianhydride. The polyamic acid may further include an optional structure. In the production method R, a monomer, such as a diamine or an acid dianhydride, may be selected and used according to a structure included in a target polyamic acid. Preferred embodiments (for example, type, content, etc.) of the polyamic acid-containing liquid, the polyamic acid included therein, and an amine, such as a diamine, an acid, such as an acid dianhydride, and a solvent, which can be used in the production method R will be described below.

### [Production Method L]

The production method L includes obtaining a polyamic acid-containing liquid that contains a polyamic acid by using a prepolymer-containing liquid that contains an amic acid prepolymer including a structure derived from an aliphatic or alicyclic diamine and a structure derived from an acid dianhydride, a diamine, and an acid dianhydride (in the present disclosure, sometimes referred to as “step L2”). The production method L can further include preparing a prepolymer-containing liquid that contains an amic acid prepolymer including a structure derived from an aliphatic or alicyclic diamine and a structure derived from an acid dianhydride (in the present disclosure, sometimes referred to as “step L1”). In the present disclosure, an amic acid prepolymer that includes a structure derived from an aliphatic or alicyclic diamine and a structure derived from an acid dianhydride may be referred to as “aliphatic or alicyclic prepolymer”, and a prepolymer-containing liquid that contains an aliphatic or alicyclic prepolymer may be referred to as “aliphatic or alicyclic prepolymer-containing liquid”. The production method L can include an optional step other than steps L1 and L2.

In the production method L, when an aliphatic or alicyclic diamine is not used, a salt of the aliphatic or alicyclic diamine does not form, and thus polymerization can proceed. Alternatively, in the production method L, polymerization can proceed even when an aliphatic or alicyclic diamine is used. One of the reasons is presumed as follows. In the production method L, when the diamine includes an aliphatic or alicyclic diamine, a polyamic acid is obtained by reacting an aliphatic or alicyclic prepolymer, an aliphatic or alicyclic diamine, and an acid dianhydride. The aliphatic or alicyclic diamine forms a salt with each of the aliphatic or alicyclic prepolymer and the acid dianhydride. When the composition ratio of the polyamic acid to be obtained is the same, in the production method L, a salt of the aliphatic or alicyclic diamine with the aliphatic or alicyclic prepolymer is formed, and thus the amount of the salt of the aliphatic or alicyclic diamine with the acid dianhydride is reduced as compared with the case where the polyamic acid is obtained using the aliphatic or alicyclic diamine and the acid dianhydride. The salt of the aliphatic or alicyclic prepolymer dissolves more easily than a salt of the acid dianhydride due to structural effects. In the production method L, the salt of the aliphatic or alicyclic prepolymer, which easily dissolves, is formed, and formation of the salt of the acid dianhydride, which is unlikely to dissolve, is suppressed. In other words, when the diamine includes the aliphatic or alicyclic diamine, the production method L is a method to promote dissolution of the entire salt by reducing a salt which is poorly soluble and including a salt which is easily soluble, thereby advancing the polymerization reaction. However, the present invention is not limited by this presumption.

In step L1, an aliphatic or alicyclic prepolymer-containing liquid is prepared. In some embodiments, step L1 may be to prepare an aliphatic or alicyclic prepolymer-containing liquid by using a previously produced prepolymer-containing liquid that contains an amic acid prepolymer including a structure derived from an aliphatic or alicyclic diamine and a structure derived from an acid dianhydride (steps L1-s). Alternatively, in some embodiments, step L1 may be to obtain an aliphatic or alicyclic prepolymer-containing liquid that contains an aliphatic or alicyclic prepolymer using an aliphatic or alicyclic diamine, an acid dianhydride, and a solvent (steps L1-i).

In step L2, a polyamic acid-containing liquid is obtained using an aliphatic or alicyclic prepolymer-containing liquid, a diamine, and an acid dianhydride. The diamine can include one or both of an aliphatic or alicyclic diamine and an aromatic diamine. For example, step L2 may be to obtain a polyamic acid-containing liquid that contains a polyamic acid by adding a diamine and an acid dianhydride to an aliphatic or alicyclic prepolymer-containing liquid (step L2-a). In a method where only one of the diamine or the acid dianhydride is added to the aliphatic or alicyclic prepolymer-containing liquid, polymerization reaction is unlikely to proceed because it is easily affected by moisture existing in the reaction system, or a poorly soluble salt is easily formed.

Embodiments of the production method L include, for example, a production method Ls including steps L1-s and L2-a, and a production method Li including steps L1-i and L2-a. In the production method Li, step L2-a is preferably performed consecutively to step L1-i.

Descriptions of steps R1-s, R1-i, and R2-a in the production method R can be applied to steps L1-s, L1-i, and L2-a in the production method L, with necessary modifications. For example, regarding method, time, temperature, and the like in steps L1-s, L1-i, and L2-a, examples given in steps R1-s, R1-i, and R2-a can be used.

However, in step L1-i, since the aliphatic or alicyclic diamine easily forms a salt with the acid dianhydride, the amounts used of the aliphatic or alicyclic diamine, the acid dianhydride, and the solvent may be adjusted to prevent precipitation of the salt, and the concentration of the obtained aliphatic or alicyclic prepolymer-containing liquid may be kept low. The content of the aliphatic or alicyclic prepolymer is particularly preferably 15.0% by mass or less relative to the mass of the aliphatic or alicyclic prepolymer-containing liquid.

When an alicyclic or aliphatic diamine and an aromatic diamine are added as diamines to the aliphatic or alicyclic prepolymer-containing liquid in step L2-a, it is preferable to add an alicyclic or aliphatic diamine solution and a solid aromatic diamine, or a solution that contains an alicyclic or aliphatic diamine and an aromatic diamine, to the aliphatic or alicyclic prepolymer-containing liquid.

The aliphatic or alicyclic prepolymer may include an optional structure other than the structure derived from an aliphatic or alicyclic diamine and the structure derived from an acid dianhydride. For example, the aliphatic or alicyclic prepolymer can include an optional structure derived from a diamine, such as a structure derived from an aromatic diamine. The content of the aliphatic or alicyclic diamine-derived structure is, for example, 50% by mass or more, 70% by mass or more, 90% by mass or more, or 100% by mass, relative to the total mass of the structure derived from a diamine.

The mass average molecular weight of the aliphatic or alicyclic prepolymer is preferably within a range from 500 to 80,000, more preferably from 1,000 to 50,000, and even more preferably from 5,000 to 30,000. The mass average molecular weight may be 10,000 or more, 20,000 or more, or 30,000 or more. When the mass average molecular weight is 500 or more, a salt formed by the aliphatic or alicyclic prepolymer and the aliphatic or alicyclic diamine has a low crystallinity and tends to dissolve easily. When the mass average molecular weight is 80,000 or less, viscosity can be prevented from becoming too high, miscibility between the acid dianhydride and the diamine becomes good, and a dissolution rate of the salt tends to increase easily.

The content of the aliphatic or alicyclic prepolymer in the aliphatic or alicyclic prepolymer-containing liquid is, for example, 15.0% by mass or less, 13.0% by mass or less, 10.0% by mass or less, or 8.0% by mass or less, relative to the mass of the aliphatic or alicyclic prepolymer-containing liquid from the viewpoint of dissolving the salt in a short time. The content of the aliphatic or alicyclic prepolymer is, for example, 3.0% by mass or more, 5.0% by mass or more, or 10.0% by mass or more, relative to the mass of the aliphatic or alicyclic prepolymer-containing liquid from the viewpoint of dissolving the salt in a short time.

The mass ratio of the aliphatic or alicyclic prepolymer used in the production method L is, for example, 10.0% by mass or more, 15.0% by mass or more, 20.0% by mass or more, 30.0% by mass or more, or 40.0% by mass or more, relative to the mass of the obtained polyamic acid from the viewpoint of dissolving the salt in a short time. The mass ratio of the aliphatic or alicyclic prepolymer is, for example, 70.0% by mass or less, 60% by mass or less, 50.0% by mass or less, 40.0% by mass or less, or 30.0% by mass or less, relative to the mass of the polyamic acid in consideration of the amount used of the diamine and the acid dianhydride.

The polyamic acid-containing liquid obtained by the production method L usually contains a polyamic acid and a solvent. The content of the polyamic acid is not particularly limited, and can be set to an appropriate content depending on application of the polyamic acid-containing liquid. In the production method L, a polyamic acid-containing liquid that contains a polyamic acid at a high concentration can be produced. The content of the polyamic acid may be, for example, 10.0% by mass or more, 15.0% by mass or more, 20.0% by mass or more, or 25.0% by mass or more, relative to the mass of the polyamic acid-containing liquid. The content of the polyamic acid may be, for example, 50.0% by mass or less, 40.0% by mass or less, or 30.0% by mass or less, relative to the mass of the polyamic acid-containing liquid.

The polyamic acid obtained using the production method L includes at least a structure derived from an aliphatic or alicyclic diamine and a structure derived from an acid dianhydride. The polyamic acid may further include an optional structure. For example, the polyamic acid can include an optional structure derived from a diamine, such as a structure derived from an aromatic diamine. In the production method L, a monomer, such as a diamine or an acid dianhydride, may be selected and used according to the structure included in a target polyamic acid. Preferred embodiments (for example, type, content, etc.) of the polyamic acid-containing liquid, the polyamic acid included therein, and an amine, such as a diamine, an acid, such as an acid dianhydride, and a solvent, which can be used in the production method L will be described below.

### <Polyamic Acid-Containing Liquid>

The polyamic acid-containing liquid contains a polyamic acid including a structure derived from an aliphatic or alicyclic diamine and a structure derived from an acid dianhydride, and a solvent. The polyamic acid may include an optional structure, such as a structure derived from an amine other than the structure derived from an aliphatic or alicyclic diamine or a structure derived from a carboxylic anhydride other than the structure derived from an acid dianhydride. The polyamic acid can further include a structure derived from a diamine, such as a structure derived from an aromatic diamine. The structure derived from an acid dianhydride preferably includes a structure derived from a pyromellitic dianhydride.

The content of the polyamic acid included in the polyamic acid-containing liquid is preferably high. When the content of the polyamic acid is high, for example, when a film is produced as a compact using the polyamic acid-containing liquid, the amount of a solvent volatilized is reduced, and a film having a more uniform in-plane film thickness is easily obtained. When the content of the polyamic acid is high, the viscosity of the polyamic acid-containing liquid can be increased, and a film having a large film thickness can be produced, depending on application.

In some embodiments, the content of a component derived from an amine and carboxylic anhydride in the polyamic acid-containing liquid is, for example, 20.0% by mass or more relative to the mass of the polyamic acid-containing liquid. In some embodiments, a mass ratio of a component derived from an amine and carboxylic anhydride, obtained by heating the polyamic acid-containing liquid, relative to the mass of the polyamic acid-containing liquid is, for example, 18.0% or more. When one or both of the content and the ratio are high, a polyamic acid-containing liquid having a high viscosity tends to be obtained.

Examples of a component derived from an amine and carboxylic anhydride (hereinafter, it may be referred to as “monomer-derived component”) include a polyamic acid, a salt of an aliphatic or alicyclic diamine with a carboxylic acid, a salt of an aliphatic or alicyclic diamine with an amic acid prepolymer, and a polyimide. The monomer-derived component includes at least one selected from these.

In some embodiments, the content of the polyamic acid in the polyamic acid-containing liquid is, for example, 20.0% by mass or more relative to the total mass of the polyamic acid and the solvent. In some embodiments, a mass ratio of the polyimide obtained by heating a filtrate of the polyamic acid-containing liquid, relative to the mass of the polyamic acid-containing liquid is, for example, 18.0% by mass or more. When one or both of the content and the ratio are high, good film forming properties tend to be obtained.

Depending on a method for producing a polyamic acid-containing liquid, a precipitate derived from a monomer, such as a salt, may occur during a production process. If the precipitate does not dissolve, it remains as solid matter in the polyamic acid-containing liquid. Preferably, the polyamic acid-containing liquid contains no solid matter, or has a low content if it contains solid matter. If the polyamic acid-containing liquid contains no solid matter or has a low content, a uniform film having excellent surface flatness is easily obtained when the polyamic acid-containing liquid is used to produce, for example, a film as a compact.

In some embodiments, the turbidity of the polyamic acid-containing liquid is, for example, 2.5 NTU (Nephelometric turbidity units) or less. When the turbidity is low, good film forming properties tend to be obtained. When the content of solid matter in the polyamic acid-containing liquid is high, the turbidity is usually high.

In a preferred embodiment, the polyamic acid-containing liquid contains a polyamic acid including a structure derived from an aliphatic or alicyclic diamine and a structure derived from an acid dianhydride, and a solvent; and satisfies at least one of (1), (2), (3), and (4) below. For example, the polyamic acid-containing liquid satisfies either or both of (1) and (2) below, or satisfies either or both of (3) and (4) below.
(1) The content of a component derived from an amine and a carboxylic anhydride is 20.0% by mass or more; and the turbidity is 2.5 NTU or less.
(2) The content of the polyamic acid is 20.0% by mass or more relative to the total mass of the polyamic acid and the solvent.
(3) The turbidity is 2.5 NTU or less; and the mass ratio of a component derived from an amine and a carboxylic anhydride, obtained by heating the polyamic acid-containing liquid, relative to the mass of the polyamic acid-containing liquid is 18.0% by mass or more.
(4) The mass ratio of the polyimide obtained by heating a filtrate of the polyamic acid-containing liquid, relative to the mass of the polyamic acid-containing liquid is 18.0% by mass or more.

The content of the monomer-derived component in the polyamic acid-containing liquid may be preferably 20.0% by mass or more, 20.1% by mass or more, 20.2% by mass or more, 20.5% by mass or more, 21.0% by mass or more, 23.0% by mass or more, 25.0% by mass or more, or 25.1% by mass or more, relative to the mass of the polyamic acid-containing liquid. The upper limit of the content of the monomer-derived component in the polyamic acid is not particularly limited. The content of the monomer-derived component is, for example, 50.0% by mass or less, 40.0% by mass or less, 30.0% by mass or less, 28.0% by mass or less, or 26.0% by mass or less, relative to the mass of the polyamic acid-containing liquid.

The ratio of the monomer-derived component obtained by heating the polyamic acid-containing liquid is preferably 18.0% by mass or more, 18.3% by mass or more, 18.5% by mass or more, 19.0% by mass or more, 20.0% by mass or more, 22.0% by mass or more, 22.5% by mass or more, 23.0% by mass or more, or 23.5% by mass or more, relative to the mass of the polyamic acid-containing liquid. The upper limit of the ratio of the monomer-derived component in the polyamic acid is not particularly limited. The ratio of the monomer-derived component is, for example, 48.0% by mass or less, 38.0% by mass or less, 28.0% by mass or less, 26.0% by mass or less, or 24.0% by mass or less, relative to the mass of the polyamic acid-containing liquid.

The content and the ratio of the monomer-derived component can be adjusted by changing the amounts of a diamine, an acid dianhydride, a solvent, and the like used for producing a polyamic acid-containing liquid. The content and the ratio of a component derived from an amine and a carboxylic anhydride can be measured using a method described in examples. Note that a calculation formula for correcting the water content may be used by appropriately changing the type and the average molecular weight of a monomer.

The content of the polyamic acid may preferably be 20.0% by mass or more, 20.1% by mass or more, 20.2% by mass or more, 20.5% by mass or more, 21.0% by mass or more, 23.0% by mass or more, 25.0% by mass or more, or 25.1% by mass or more, relative to the mass of the polyamic acid-containing liquid. The upper limit of the content of the polyamic acid is not particularly limited. The content of the polyamic acid is, for example, 50.0% by mass or less, 40.0% by mass or less, 30.0% by mass or less, 28.0% by mass or less, or 26.0% by mass or less, relative to the mass of the polyamic acid-containing liquid.

The ratio of a polyimide obtained by heating a filtrate of the polyamic acid-containing liquid is preferably 18.0% by mass or more, 18.3% by mass or more, 18.5% by mass or more, 19.0% by mass or more, 20.0% by mass or more, 22.0% by mass or more, 22.5% by mass or more, 23.0% by mass or more, or 23.5% by mass or more, relative to the mass of the polyamic acid-containing liquid. The upper limit of the polyimide ratio is not particularly limited. The polyimide ratio is, for example, 48.0% by mass or less, 38.0% by mass or less, 28.0% by mass or less, 26.0% by mass or less, or 24.0% by mass or less, relative to the mass of the polyamic acid-containing liquid.

A polyamic acid-containing liquid having a high polyamic acid content or a high polyimide ratio can be easily produced, for example, by the production method of at least one of the above-described embodiments. The polyamic acid content and the polyimide ratio can be measured by using a filtrate obtained by filtering the polyamic acid-containing liquid to remove solid matter derived from a monomer, such as a salt. A 150 mesh filter made of stainless steel can be used for the filtration. The polyamic acid content and the polyimide ratio can be measured specifically using a method described in examples. Note that a formula for correcting the water content may be used by appropriately changing the type and the average molecular weight of a monomer.

The content of the polyamic acid and the ratio of the polyimide may be the content or the ratio at a temperature when the polyamic acid-containing liquid is actually used. Alternatively, the temperature of the polyamic acid-containing liquid when the content and the ratio is obtained may be different from the temperature when the polyamic acid-containing liquid is actually used. The content and the ratio may be, for example, a content or a ratio when the temperature of the polyamic acid-containing liquid is within a range from 20° C. to 35° C., and preferably, when the temperature of the polyamic acid-containing liquid is 25° C. In this case, the polyamic acid-containing liquid may be filtered at a temperature of 20° C. to 35° C. (preferably, 25° C.), and the content or the ratio may be measured using an obtained filtrate.

The turbidity of the polyamic acid-containing liquid is preferably 2.5 NTU or less, 2.0 NTU or less, 1.5 NTU or less, 1.0 NTU or less, or 0.5 NTU or less, or 0 NTU. In the present disclosure, the turbidity is based on a formazine standard solution measured using a transmitted and scattered light method. The turbidity can be measured specifically using a method described in examples. Usually, the smaller the turbidity, the lower the content of solid matter, such as a salt. The turbidity may be at a temperature when the polyamic acid-containing liquid is actually used. Alternatively, the temperature of the polyamic acid-containing liquid when the turbidity is obtained may be different from the temperature when the polyamic acid-containing liquid is actually used. The turbidity may be, for example, when the temperature of the polyamic acid-containing liquid is within a range from 20° C. to 35° C., and preferably when the temperature of the polyamic acid-containing liquid is 25° C.

The viscosity (ninh) of the polyamic acid-containing liquid is preferably 0.3 dL/g or more, more preferably 0.5 dL/g or more, and even more preferably 0.6 dL/g or more. The viscosity of the polyamic acid-containing liquid is, for example, 1.5 dL/g or less, 1.3 dL/g or less, or 1.0 dL/g or less. The viscosity of the polyamic acid-containing liquid is measured at 30° C. using an Ostwald viscometer. The viscosity can be measured specifically using a method described in examples.

The mass average molecular weight of the polyamic acid is preferably within a range from 5,000 to 130,000, more preferably from 10,000 to 120,000, even more preferably from 15,000 to 110,000, and particularly preferably from more than 15,000 to 100,000 or less. When the mass average molecular weight is within the above ranges, good film forming properties tend to be obtained.

In the polyamic acid, the content of a structure derived from an aliphatic or alicyclic diamine is preferably 20% by mass or more, and for example, 30% by mass or more, 50% by mass or more, 70% by mass or more, or 80% by mass or more, or 100% by mass, relative to the total of the structure derived from a diamine included in the polyamic acid. When the content is 20% by mass or more, excellent permittivity properties tend to be obtained. The content of a structure derived from an aliphatic or alicyclic diamine may be, for example, 80% by mass or less, 60% by mass or less, 50% by mass or less, or 40% by mass or less, relative to the total of the structure derived from a diamine included in the polyamic acid.

In the polyamic acid, the content of a structure derived from an aromatic diamine is preferably 80% by mass or less, and for example, 70% by mass or less, 50% by mass or less, 30% by mass or less, or 20% by mass or less, or 0% by mass, relative to the total of the structure derived from a diamine included in the polyamic acid. When the polyamic acid includes a structure derived from an aromatic diamine, the content of the structure derived from an aromatic diamine may be, from the viewpoint of mechanical strength, 20% by mass or more, 40% by mass or more, 50% by mass or more, or 60% by mass or more, relative to the total of the structure derived from a diamine included in the polyamic acid.

In the polyamic acid, the content of a structure derived from a pyromellitic dianhydride is preferably 50% by mass or more, and for example, 70% by mass or more or 85% by mass or more, or 100% by mass, relative to the total mass of the structure derived from an acid dianhydride included in the polyamic acid.

In the polyamic acid, the content of a structure derived from an aliphatic or alicyclic diamine is preferably 20% by mass or more relative to total mass of the structure derived from a diamine included in the polyamic acid, and the content of a structure derived from an acid dianhydride is preferably 50% by mass or more relative to the total mass of the structure derived from an acid dianhydride included in the polyamic acid. The molar ratio of the structure derived from a diamine to the structure derived from an acid dianhydride is, for example, within a range from 1.00:0.90 to 1.00:1.10, and preferably from 1.00:0.95 to 1.00:1.05.

Examples of a structure derived from a diamine and a structure derived from an acid dianhydride which the polyamic acid can include will be described below. The structure derived from an aliphatic or alicyclic diamine preferably includes a structure derived from an alicyclic diamine, and more preferably includes a structure derived from a dimer diamine. When the polyamic acid includes a structure derived from a dimer diamine, the permittivity and dielectric loss tangent of the polyimide can be lowered. The polyimide having a low permittivity and a low dielectric loss tangent can control transmission loss, and thus is suitable for the application as a substrate, such as FPC, an antenna for high frequency, and the like.

The polyamic acid-containing liquid contains a solvent. The polyamic acid-containing liquid can contain an optional component other than the polyamic acid and the solvent. Examples of the solvent that the polyamic acid-containing liquid can include will be described below. The solvent may be a polar organic solvent and preferably includes an amide-based solvent containing an amide linkage.

Although the method for producing a polyamic acid-containing liquid is not particularly limited, the method of at least one of the above-described embodiments may be preferably used.

### <Diamine>

A diamine that can be used in the method for producing a polyamic acid-containing liquid of at least one of the above-described embodiments, and a diamine in a “diamine-derived structural unit” included in the polyamic acid contained in the polyamic acid-containing liquid of at least one of the above-described embodiments, may include an aromatic diamine, an aliphatic or alicyclic diamine, or both.

In the present disclosure, the aromatic diamine may be a diamine having at least one aromatic ring and two amino groups bonded to the at least one aromatic ring. When the aromatic diamine has two or more aromatic rings, the two or more aromatic rings may be the same or different from each other. When the aromatic diamine has two or more aromatic rings, two amino groups may be bonded to one aromatic ring, or two amino groups may each be bonded to different aromatic rings. The aromatic diamine may further have at least one selected from an aliphatic hydrocarbon group and an alicyclic hydrocarbon group.

In the present disclosure, the aliphatic or alicyclic diamine may be a diamine that has at least one selected from an aliphatic hydrocarbon group and an alicyclic hydrocarbon group, and two amino groups, and does not correspond with the aromatic diamine. The aliphatic or alicyclic diamine may further have at least one aromatic ring. At least one of the two amino groups is bonded to an aliphatic hydrocarbon group or an alicyclic hydrocarbon group. Both of the two amino groups may be bonded to an aliphatic hydrocarbon group or an alicyclic hydrocarbon group, or only one of the two amino groups may be bonded to an aliphatic or alicyclic diamine. When the aliphatic or alicyclic diamine has two or more groups selected from an aliphatic hydrocarbon group and an alicyclic hydrocarbon group, the two or more groups may be the same or different from each other. When the aliphatic or alicyclic diamine has two or more groups selected from an aliphatic hydrocarbon group and an alicyclic hydrocarbon group, two amino groups may be bonded to a group selected from an aliphatic hydrocarbon group and an alicyclic hydrocarbon group, or the two amino groups may each be bonded to different groups selected from an aliphatic hydrocarbon group and an alicyclic hydrocarbon group. An amino group bonded to an aliphatic hydrocarbon group or an alicyclic hydrocarbon group has stronger basicity than an amino group bonded to an aromatic ring, and thus is more likely to form a salt with a carboxylic acid.

Examples of the aromatic diamine include diamines having an aromatic hydrocarbon group or an aromatic heterocyclic group, such as 1,4-phenylenediamine, 1,2-phenylenediamine, 1,3-phenylenediamine, 4,4′-(biphenyl-2,5-diylbisoxy)bisaniline, 4,4′-diaminodiphenyl ether, 3,4′-diaminodiphenyl ether, 1,4-bis(4-aminophenoxy)benzene, 1,3-bis(4-aminophenoxy)benzene, 2,2-bis(4-(4-aminophenoxy)phenyl) propane, bis(4-(4-aminophenoxy)phenyl) sulfone, bis(4-(3-aminophenoxy)phenyl) sulfone, 1,3-bis(4-aminophenoxy) neopentane, 4,4′-diamino-3,3′-dimethylbiphenyl, 4,4′-diamino-2,2′-dimethylbiphenyl, 4,4′-bis(4-aminophenoxy) biphenyl, 4,4′-diamino-3,3′-dihydroxybiphenyl, bis(4-amino-3-carboxyphenyl) methane, 4,4′-diaminodiphenyl sulfone, 3,3′-diaminodiphenyl sulfone, 4,4′-diaminodiphenyl sulfide, N-(4-aminophenoxy)-4-aminobenzamine, 2,2′-bis(trifluoromethyl)-4,4′-diaminobiphenyl, bis(3-aminophenyl) sulfone, 4,4′-diamino-2-(trifluoromethyl) diphenyl ether, 5-trifluoromethyl-1,3-benzenediamine, 2,2-bis(4-(4-aminophenoxy)phenyl) hexafluoropropane, 4,4′-diamino-2,2′-bis(trifluoromethyl) biphenyl, 2,2-bis [4-{4-amino-2-(trifluoromethyl) phenoxy}phenyl]hexafluoropropane, 2-trifluoromethyl-p-phenylenediamine, 2,2-bis(3-amino-4-methylphenyl) hexafluoropropane, 4,4′-(9-fluorenylidene) dianiline, 2,7-diaminofluorene, 1,5-diaminonaphthalene, and 3,7-diamino-2, 8-dimethyldibenzothiophene5,5-dioxide.

Examples of the aliphatic or alicyclic diamine include:
diamines having a saturated aliphatic hydrocarbon group, such as 1,2-ethylenediamine, 1,2-diaminopropane, 1,3-diaminopropane, 1,4-diaminobutane, 1,5-diaminopentane, 1,6-diaminohexane, 1,9-diaminononane, 1,10-diaminodecane, 1,11-diaminoundecane, 1,12-diaminododecane, 1,14-diaminotetradecane, and 1,16-diaminohexadecane;
diamines having an unsaturated aliphatic hydrocarbon group, such as 1,9-diaminononene, 1,10-diaminodecene, 1,11-diaminoundecene, 1,12-diaminododecene, 1,14-diaminotetradecene, and 1,16-diaminohexadecene;
diamines having a saturated aliphatic hydrocarbon group, such as 1,4-diaminocyclohexane, 1,3-bis(aminomethyl) cyclohexane, 1,4-bis(aminomethyl) cyclohexane, norbornanediamine, isophoronediamine, bis(aminomethyl) norbornane, 1,3-diaminoadamantane, 4,4′-diaminodicyclohexylmethane, 3,3′-dimethyl-4,4′-diaminodicyclohexylmethane, 3,3′-diethyl-4,4′-diaminodicyclohexylmethane, 3,3′,5,5′-tetramethyl-4,4′-diaminodicyclohexylmethane, 3,3′,5,5′-tetraethyl-4,4′-diaminodicyclohexylmethane, 3,5-diethyl-3′,5′-dimethyl-4,4′-diaminodicyclohexylmethane, 4,4′-diaminodicyclohexyl ether, 3,3′-dimethyl-4,4′-diaminodicyclohexyl ether, 3,3′-diethyl-4,4′-diaminodicyclohexyl ether, 3,3′,5,5′-tetramethyl-4,4′-diaminodicyclohexyl ether, 3,3′,5,5′-tetraethyl-4,4′-diaminodicyclohexyl ether, 3,5-diethyl-3′,5′-dimethyl-4,4′-diaminodicyclohexyl ether, 2,2-bis(4-aminocyclohexyl) propane, 2,2-bis(3-methyl-4 aminocyclohexyl) propane, 2,2-bis(3-methyl-4-aminocyclohexyl) propane, 2,2-bis(3,5-dimethyl-4-aminocyclohexyl) propane, 2,2-bis(3,5-diethyl-4-aminocyclohexyl) propane, and 2,2-(3,5-diethyl-3′,5′-dimethyl-4,4′-diaminodicyclohexyl) propane;
diamines having an unsaturated alicyclic hydrocarbon group, such as bis(aminomethyl) norbornene, and 4,4′-diaminodicyclohexenylmethane;
dimer diamines including: diamines derived from dimers (also referred to as dimer acid) of unsaturated fatty acids, such as: monounsaturated fatty acids, such as crotonic acid, myristoleic acid, palmitoleic acid, sapienoic acid, oleic acid, elaidic acid, vaccenic acid, gadoleic acid, eicosenoic acid, erucic acid, and nervonic acid, diunsaturated fatty acids, such as linoleic acid, eicosadienoic acid, and docosadienoic acid, and triunsaturated fatty acids, such as linolenic acid, pinolenic acid, eleostearic acid, mead acid, dihomo-γ-linolenic acid, and eicosatrienoic acid; and hydrogenated diamines in which a carbon-carbon double bond in the molecule of these diamines is hydrogenated.

The diamine preferably includes an alicyclic diamine from the viewpoint of lowering the permittivity. In particular, the diamine more preferably includes at least one selected from dimer diamines (a non-hydrogenated dimer diamine and a hydrogenated dimer diamine). When the polyamic acid includes a structure derived from a dimer diamine, the permittivity and the dielectric loss tangent of the polyimide can be lowered. The diamine preferably includes an aromatic diamine from the viewpoint of maintaining mechanical strength.

In the polyamic acid, the content of a structure derived from an aliphatic or alicyclic diamine is preferably 20% by mass or more relative to the total mass of the structure derived from a diamine included in the polyamic acid. More preferably, 30% by mass or more, 50% by mass or more, 70% by mass or more, or 90% by mass or more, or 100% by mass. The content of a structure derived from an aliphatic or alicyclic diamine is 100% by mass or less, and for example 90% by mass or less, or 70% by mass or less, relative to the total mass of the structure derived from a diamine included in the polyamic acid.

### <Tetracarboxylic Dianhydride>

A tetracarboxylic dianhydride that can be used in the method for producing a polyamic acid-containing liquid according to at least one of the above-described embodiments, and a tetracarboxylic dianhydride in a “tetracarboxylic dianhydride-derived structural unit” included in the polyamic acid contained in the polyamic acid-containing liquid according to at least one of the above-described embodiments, may include an aromatic tetracarboxylic dianhydride, an aliphatic or alicyclic tetracarboxylic dianhydride, or both of these.

In the present disclosure, the aromatic tetracarboxylic dianhydride may be a compound having at least one aromatic ring and two acid anhydride groups bonded to at least one aromatic ring. When the aromatic tetracarboxylic dianhydride has two or more aromatic rings, the two or more aromatic rings may be the same or different from each other. When the aromatic tetracarboxylic dianhydride has two or more aromatic rings, the two acid anhydride groups may be bonded to one aromatic ring, or the two acid anhydride groups may each be bonded to different aromatic rings. The aromatic tetracarboxylic dianhydride may further have at least one group selected from an aliphatic hydrocarbon group and an alicyclic hydrocarbon group.

In the present disclosure, the aliphatic or alicyclic tetracarboxylic dianhydride may be a diamine that has at least one selected from an aliphatic hydrocarbon group and an alicyclic hydrocarbon group, and two acid anhydride groups, and does not correspond with the aromatic tetracarboxylic dianhydride. The aliphatic or alicyclic tetracarboxylic dianhydride may further have at least one aromatic ring.

Examples of the aromatic tetracarboxylic dianhydride include a tetracarboxylic dianhydride having an aromatic hydrocarbon group, such as pyromellitic dianhydride, 1,2,3,4-benzenetetracarboxylic dianhydride, 1,1-bis(2,3-dicarboxyphenyl) ethane dianhydride, bis(2,3-dicarboxyphenyl) methane dianhydride, bis(3,4-dicarboxyphenyl) methane dianhydride, 3,3′,4,4′-biphenyltetracarboxylic dianhydride, 2,2-bis(3,4-dicarboxyphenyl) propane dianhydride, 2,2-bis(2,3-dicarboxyphenyl) propane dianhydride, bis(3,4-dicarboxyphenyl) sulfone dianhydride, bis(3,4-dicarboxyphenyl) ether dianhydride, bis(2,3-dicarboxyphenyl) ether dianhydride, 3,3′,4,4′-benzophenone tetracarboxylic dianhydride, 2,2′,3,3′-benzophenone tetracarboxylic dianhydride, 4,4′-oxydiphthalic dianhydride, 4,4-(p-phenylenedioxy) diphthalic dianhydride, 4,4-(m-phenylenedioxy) diphthalic dianhydride, 2,2′, 6,6′-biphenyltetracarboxylic dianhydride, 2,2-bis(3,4-dicarboxyphenyl)-1,1,1,3,3,3-hexafluoropropane dianhydride, 2,2-bis(2,3-dicarboxyphenyl)-1,1,1,3,3,3-hexafluoropropane dianhydride, 2,2′-bis(trifluoromethyl)-4,4′,5,5′-biphenyltetracarboxylic dianhydride, 4,4′-(hexafluorotrimethylene)-diphthalic dianhydride, 4,4′-(octafluorotetramethylene)-diphthalic dianhydride, 1,2,5,6-naphthalenedicarboxylic dianhydride, 1,4,5,8-naphthalenedicarboxylic dianhydride, 2,3,6,7-naphthalenedicarboxylic dianhydride, 3,4,9,10 perylenetetracarboxylic dianhydride, 2,3,6,7-anthracenetetracarboxylic dianhydride, and 1,2,7,8-phenanthrenetetracarboxylic dianhydride.

Examples of the aliphatic or alicyclic tetracarboxylic dianhydride include:
tetracarboxylic dianhydrides having a saturated aliphatic hydrocarbon group, such as ethylenetetracarboxylic dianhydride, and butanetetracarboxylic dianhydride;
tetracarboxylic dianhydrides having a saturated alicyclic hydrocarbon group, such as 1,2,3,4-cyclobutane tetracarboxylic dianhydride, 1,2,3,4-cyclopentane tetracarboxylic dianhydride, 1,2,4,5-cyclohexane tetracarboxylic dianhydride, and 1,2,3,4-tetramethyl-1,2,3,4-cyclobutane tetracarboxylic dianhydride;
tetracarboxylic dianhydrides having an alicyclic hydrocarbon group, such as 1,1-bis(2,3-dicarboxycyclohexyl) ethane dianhydride, bis(2,3-dicarboxycyclohexyl) methane dianhydride, bis(3,4-dicarboxycyclohexyl) methane dianhydride, 3,3′,4,4′-bicyclohexyltetracarboxylic dianhydride, 2,2-bis(3,4-dicarboxycyclohexyl) propane dianhydride, 2,2-bis(2,3-dicarboxycyclohexyl) propane dianhydride, bis(3,4-dicarboxycyclohexyl) sulfone dianhydride, bis(3,4-dicarboxycyclohexyl) ether dianhydride, bis(2,3-dicarboxycyclohexyl) ether dianhydride, 2,2′, 6,6′-bicyclohexyltetracarboxylic dianhydride, 1,2,5,6-decahydronaphthalenedicarboxylic dianhydride, 1,4,5,8-decahydronaphthalenedicarboxylic dianhydride, 2,3,6,7-decahydronaphthalenedicarboxylic dianhydride, octahydrobiphenylene-4a, 8b: 4b,8a-tetracarboxylic dianhydride, 1,2,3,4-tetramethyl-1,2,3,4-cyclobutane tetracarboxylic dianhydride, dicyclohexyl-3,4,3′,4′-tetracarboxylic dianhydride, and 5-(2,5-dioxotetrahydrofuryl)-3-methyl-3-cyclohexene-1,2-dicarboxylic anhydride.

In the polyamic acid, the tetracarboxylic dianhydride preferably includes an aromatic tetracarboxylic dianhydride. In particular, the tetracarboxylic dianhydride preferably includes at least one selected from pyromellitic dianhydride and 3,3′,4,4′-biphenyltetracarboxylic dianhydride.

The content of the structure derived from a pyromellitic dianhydride is preferably 50% by mass or more relative to the total mass of the structure derived from an acid dianhydride included in the polyamic acid. More preferably, the content is 60% by mass or more, 70% by mass or more, 80% by mass or more, or 90% by mass or more, or 100% by mass. The content of the structure derived from a pyromellitic dianhydride is 100% by mass or less, and for example, 90% by mass or less, or 70% by mass or less, relative to the total mass of the structure derived from an acid dianhydride included in the polyamic acid.

### <Other Monomers>

In the method for producing a polyamic acid-containing liquid of at least one of the above-described embodiments, an optional monomer, such as an amine other than the diamine, and an acid anhydride other than the tetracarboxylic dianhydride, can be used. The polyamic acid contained in the polyamic acid-containing liquid of at least one of the above-described embodiments can include an optional structure, such as a structure derived from an amine other than diamine, and a structure derived from an acid anhydride other than a tetracarboxylic dianhydride. Examples of the amine include diamines, monoamines, and trifunctional or higher amines. Examples of the acid anhydride include tetracarboxylic dianhydrides, dicarboxylic anhydrides, and tricarboxylic anhydrides.

In the polyamic acid, the content of a structure derived from a diamine is, for example, 90% by mass or more, 95% by mass or more, or 100% by mass, relative to the total mass of the structure derived from an amine included in the polyamic acid. In the polyamic acid, the content of a structure derived from a tetracarboxylic dianhydride is, for example, 90% by mass or more, 95% by mass or more, or 100% by mass, relative to the total mass of the structure derived from an acid anhydride included in the polyamic acid.

### <Solvent>

Examples of a solvent that can be used in the method for producing a polyamic acid-containing liquid of at least one of the above-described embodiments, and a solvent that can be contained in the polyamic acid-containing liquid of at least one of the above-described embodiments, include polar organic solvents, such as N-methyl-2-pyrrolidone (NMP), N-ethyl-2-pyrrolidone (NEP), γ-butyrolactone (GBL), 3-methoxy-N,N-dimethylpropanamide (MPA), N,N′-dimethylformamide, N,N′-dimethylpropyleneurea [1,3-dimethyl-3,4,5,6-tetrahydropyridimine-2 (1H)-one], dimethyl sulfoxide, dimethylacetamide (DMAc), diethylene glycol dimethyl ether, and triethylene glycol dimethyl ether. The solvent preferably includes at least one selected from the group consisting of N-methyl-2-pyrrolidone (NMP), N-ethyl-2-pyrrolidone (NEP), γ-butyrolactone (GBL), 3-methoxy-N,N-dimethylpropanamide (MPA), and dimethylacetamide (DMAc), and more preferably includes at least one selected from the group consisting of N-methyl-2 pyrrolidone (NMP), γ-butyrolactone (GBL), 3-methoxy-N,N-dimethylpropanamide (MPA), and dimethylacetamide (DMAc).

### <Polyamic Acid-Containing Liquid for Insulating Material, Heat-Resistant Insulating Material, or Printed Board>

The polyamic acid-containing liquid can be preferably used as a composition for an insulator, a composition for a heat-resistant insulator, or a composition for a printed board. These compositions may further contain an optional component, such as a polyamide, a polyether sulfone, an acrylic polymer, an epoxy compound, an isocyanate compound, a melamine compound, a filler, an antifoaming agent, a preservative, or a surfactant, depending on application. A composition can be produced, for example, using a method of mixing and stirring the polyamic acid-containing liquid with an optional component to be used as necessary. The content of the polyamic acid can be set in a range suitable for the application of the composition. The content of the polyamic acid is, for example, within a range from 5% to 30% by mass, from 8% to 25% by mass, or from 10% to 23% by mass, relative to the mass of the composition.

### <Polyimide>

The polyimide is obtained by performing cyclodehydration of the polyamic acid (this may be referred to as “imidization”). The method for producing the polyimide includes obtaining the polyimide by using the polyamic acid-containing liquid. The method for imidization is not particularly limited. For simplicity, a method of heating the polyamic acid-containing liquid can preferably be used. The heating temperature is, for example, within a range from 250° C. to 400° C.

### <Compact, Insulator, or Heat-Resistant Insulator>

The polyamic acid can be used for producing a compact, an insulator, or a heat-resistant insulator. The method for producing a compact, an insulator, or a heat-resistant insulator includes obtaining the compact, the insulator, or the heat-resistant insulator by using the polyamic acid-containing liquid. The shape of the compact, insulator, or heat-resistant insulator is not particularly limited, and may be suited for the application. For example, the shape may be a film, a plate, a membrane, a layer, or the like. The compact, insulator, or heat-resistant insulator can be used for various electronic components and mechanical components.

### <Printed Board>

The polyamic acid can be used for producing a printed board. The method for producing a printed board includes obtaining a printed board by using the polyamic acid-containing liquid. Examples of the printed board include a printed wiring board and a printed circuit board. Examples of the printed board include a flexible board and a rigid board. Examples of the printed board include a single-sided board, a double-sided board, and a multilayer board. For example, a substrate material, a protective film, an insulating layer, or the like for these boards can be obtained using the polyamic acid-containing liquid.

An example of the flexible board is a board including a base film that is obtained using the polyamic acid-containing liquid. Another example of the flexible board is a board including a base film and a heat-resistant insulating layer formed on the base film, where at least the heat-resistant insulating layer is obtained using the polyamic acid-containing liquid.

### EXAMPLE EMBODIMENTS

Preferred examples of embodiments of the present invention will be described below. Embodiments of the present invention are not limited to the following examples.
[1] A method for producing a polyamic acid-containing liquid including obtaining a polyamic acid-containing liquid that contains a polyamic acid, by using a prepolymer-containing liquid that contains an amic acid prepolymer, a diamine, and a tetracarboxylic acid. In the present disclosure, the amic acid prepolymer is a polyamic acid that includes a structure derived from a diamine and a structure derived from a tetracarboxylic acid.
[2] The method for producing a polyamic acid-containing liquid according to [1] above, including any one of step (1) and step (2) below:
   (1) obtaining a polyamic acid-containing liquid that contains a polyamic acid, by using a prepolymer-containing liquid that contains an amic acid prepolymer including a structure derived from an aromatic diamine and a structure derived from a tetracarboxylic dianhydride, an aliphatic or alicyclic diamine, and a tetracarboxylic dianhydride; or
   (2) obtaining a polyamic acid-containing liquid that contains a polyamic acid, by using a prepolymer-containing liquid that contains an amic acid prepolymer including a structure derived from an aliphatic or alicyclic diamine and a structure derived from a tetracarboxylic dianhydride, a diamine, and a tetracarboxylic dianhydride.

Preferred embodiments of step (1) above include [3] to [10] below. Preferred embodiments of step (2) above include [11] to [17] below.

The polyamic acid obtained is preferably any one of [18] to [31] below.
[3] A method for producing a polyamic acid-containing liquid including: obtaining a polyamic acid-containing liquid that contains a polyamic acid, by using a prepolymer-containing liquid that contains an amic acid prepolymer including a structure derived from an aromatic diamine and a structure derived from a tetracarboxylic dianhydride, an aliphatic or alicyclic diamine, and a tetracarboxylic dianhydride.
[4] The method for producing a polyamic acid-containing liquid according to [3] above, including: obtaining the prepolymer-containing liquid by using an aromatic diamine, a tetracarboxylic dianhydride, and a solvent; and obtaining the polyamic acid-containing liquid by adding the aliphatic or alicyclic diamine and the tetracarboxylic dianhydride to the prepolymer-containing liquid.
[5] The method for producing a polyamic acid-containing liquid according to [3] or [4] above, including adding one or both of the aliphatic or alicyclic diamine and the tetracarboxylic dianhydride to the prepolymer-containing liquid in two or more portions.
[6] The method for producing a polyamic acid-containing liquid according to any one of [3] to [5] above, wherein a content of the amic acid prepolymer in the prepolymer-containing liquid is 30.0% by mass or less.
[7] The method for producing a polyamic acid-containing liquid according to any one of [3] to [6] above, wherein a mass of the amic acid prepolymer relative to a mass of the polyamic acid is 10.0% by mass or more.
[8] The method for producing a polyamic acid-containing liquid according to any one of [3] to [7] above, wherein a content of the amic acid prepolymer in the prepolymer-containing liquid is 15.0% by mass or more, and a mass of the amic acid prepolymer relative to a mass of the polyamic acid is 50.0% by mass or more.
[9] The method for producing a polyamic acid-containing liquid according to any one of [3] to [8] above, wherein the amic acid prepolymer further includes a structure derived from an aliphatic or alicyclic diamine.
[10] A method for producing a polyamic acid-containing liquid, satisfying any one of embodiments [3] to [9] above, and any one of embodiments [18] to [31] below.
[11] A method for producing a polyamic acid-containing liquid, including: obtaining a polyamic acid-containing liquid that contains a polyamic acid, by using a prepolymer-containing liquid that contains an amic acid prepolymer including a structure derived from an aliphatic or alicyclic diamine and a structure derived from a tetracarboxylic dianhydride, a diamine, and a tetracarboxylic dianhydride.
[12] The method for producing a polyamic acid-containing liquid according to [11] above, including: obtaining the prepolymer-containing liquid by using an aliphatic or alicyclic diamine, a tetracarboxylic dianhydride, and a solvent; and
   obtaining the polyamic acid-containing liquid by adding the diamine and the tetracarboxylic dianhydride to the prepolymer-containing liquid.
[13] The method for producing a polyamic acid-containing liquid according [11] to [12] or above, including adding one or both of the diamine and the tetracarboxylic dianhydride to the prepolymer-containing liquid in two or more portions.
[14] The method for producing a polyamic acid-containing liquid according to any one of [11] to [13] above, wherein a content of the amic acid prepolymer in the prepolymer-containing liquid is 15.0% by mass or less.
[15] The method for producing a polyamic acid-containing liquid according to any one of [11] to [14] above, wherein a mass of the amic acid prepolymer relative to a mass of the polyamic acid is 10.0% by mass or more.
[16] The method for producing a polyamic acid-containing liquid according to any one of [11] to [15] above, wherein the amic acid prepolymer further includes a structure derived from an aromatic diamine.
[17] A method for producing a polyamic acid-containing liquid, satisfying any one of embodiments [11] to [16] above, and any one of embodiments [18] to [31] below.
[18] A polyamic acid-containing liquid, including: a polyamic acid including a structure derived from an aliphatic or alicyclic diamine and a structure derived from a tetracarboxylic dianhydride, and a solvent; and satisfying one or both of (1) and (2) below:
   (1) a content of a component derived from an amine and a carboxylic anhydride is 20.0% by mass or more; and a turbidity is 2.5 NTU or less; and
   (2) a content of the polyamic acid is 20.0% by mass or more relative to a total mass of the polyamic acid and the solvent.
[19] The polyamic acid-containing liquid according to [18] above, satisfying the above-described (1).
[20] The polyamic acid-containing liquid according to [18] or [19] above, satisfying the above-described (2).
[21] A polyamic acid-containing liquid, including: a polyamic acid including a structure derived from an aliphatic or alicyclic diamine and a structure derived from a tetracarboxylic dianhydride, and a solvent; and
   satisfying one or both of (3) and (4) below:
   (3) a turbidity is 2.5 NTU or less; and a mass ratio of a component derived from an amine and a carboxylic anhydride, obtained by heating the polyamic acid-containing liquid, relative to a mass of the polyamic acid-containing liquid is 18.0% by mass or more; and
   (4) a mass ratio of a polyimide obtained by heating a filtrate of the polyamic acid-containing liquid, relative to a mass of the polyamic acid-containing liquid is 18.0% by mass or more.
[22] The polyamic acid-containing liquid according to [21] above, satisfying the above-described (3). The polyamic acid-containing liquid may further satisfy any one of [18] to [20] above.
[23] The polyamic acid-containing liquid according to [21] or [22] above, satisfying the above-described (4). The polyamic acid-containing liquid may further satisfy any one of to above.
[24] The polyamic acid-containing liquid according to any one of [18] to [23] above, wherein the structure derived from a tetracarboxylic dianhydride includes a structure derived from a pyromellitic dianhydride.
[25] The polyamic acid-containing liquid according to any one of [18] to [24] above, wherein the polyamic acid further includes a structure derived from an aromatic diamine.
[26] The polyamic acid-containing liquid according to any one of [18] to [25] above, wherein a content of the structure derived from an aliphatic or alicyclic diamine is 20% by mass or more relative to a total mass of a structure derived from an diamine included in the polyamic acid.
[27] The polyamic acid-containing liquid according to [24], wherein a content of the structure derived from a pyromellitic dianhydride is 50% by mass or more relative to a total mass of a structure derived from a tetracarboxylic dianhydride included in the polyamic acid.
[28] The polyamic acid-containing liquid according to any one of [24] to [27] above, wherein
   a content of the structure derived from an aliphatic or alicyclic diamine is 20% by mass or more relative to a total mass of a structure derived from a diamine included in the polyamic acid, and
   a content of the structure derived from a pyromellitic dianhydride is 50% by mass or more relative to a total mass of a structure derived from an acid dianhydride included in the polyamic acid.
[29] The polyamic acid-containing liquid according to any one of [18] to [28] above, wherein the structure derived from an aliphatic or alicyclic diamine includes a structure derived from an alicyclic diamine.
[30] The polyamic acid-containing liquid according to any one of [18] to [29] above, wherein the structure derived from an aliphatic or alicyclic diamine includes a structure derived from a dimer diamine.
[31] The polyamic acid-containing liquid according to any one of [18] to [30] above, which is for an insulating material use, a heat-resistant insulating material use, or a printed board use.
[32] A method for producing a polyimide including obtaining a polyimide by using the polyamic acid-containing liquid according to any one of [18] to [31] above.
[33] A method for producing a compact including obtaining a compact by using the polyamic acid-containing liquid according to any one of [18] to [31] above.
[34] A method for producing a printed board including obtaining a printed board using the polyamic acid-containing liquid according to any one of [18] to [31] above.

### EXAMPLES

Embodiments of the present invention will be specifically described using examples. Embodiments of the present invention are not limited to the following examples.

Abbreviations used in examples represent the following.
PMDA: Pyromellitic dianhydride
ODA: Oxydianiline
PACM: Paradiaminodicyclohexylmethane
NBDA: Norbornane diamine
DDA: Dimer diamine (molecular weight 534.99, “PRIAMINE1075”, Croda Japan K.K.)
DMAc: Dimethylacetamide

### <Preparation and Evaluation of Polyamic Acid-Containing Liquid (1)>

A polyamic acid-containing liquid was prepared using the production method Rs or the production method Ls, and was evaluated.

### Example 1

An amic acid prepolymer-containing liquid that contains an amic acid prepolymer (0.586 g) and dehydrated DMAc (4.696 g) shown in Table 1 was prepared in a 50 mL screw tube in a fume hood. Next, ODA (0.295 g, 1.47 mmol), PACM (0.575 g, 2.73 mmol), and dehydrated DMAc (4.683 g) were charged into a sample bottle and stirred to prepare a diamine solution. The total amount of the diamine solution and PMDA (0.910 g, 0.417 mmol) was added to the amic acid prepolymer-containing liquid and stirred at room temperature for 24 hours in total to obtain a polyamic acid-containing liquid 1.

### Example 2

An amic acid prepolymer-containing liquid that contains an amic acid prepolymer (0.588 g) and dehydrated DMAc (4.694 g) shown in Table 1 was prepared in a 50 mL screw tube in a fume hood. Next, PACM (0.863 g, 4.10 mmol) and dehydrated DMAc (4.683 g) were charged into a sample bottle and stirred to prepare a diamine solution. The total amount of the diamine solution and PMDA (0.900 g, 0.410 mmol) was added to the amic acid prepolymer-containing liquid and stirred at room temperature for 8 hours to obtain a polyamic acid-containing liquid 2.

### Example 3

An amic acid prepolymer-containing liquid that contains an amic acid prepolymer (0.588 g) and dehydrated DMAc (4.694 g) shown in Table 1 was prepared in a 50 mL screw tube in a fume hood. Next, PACM (0.863 g, 4.10 mmol) and dehydrated DMAc (4.683 g) were charged into a sample bottle and stirred to prepare a diamine solution. Then, the diamine solution and PMDA (0.900 g, 4.10 mmol) were each divided into four equal portions and added one portion at a time into the amic acid prepolymer-containing liquid every 10 minutes while stirring, and then stirred at room temperature for 8 hours in total to obtain a polyamic acid-containing liquid 3. The stirring time is the time from the first addition to the end of stirring.

### Example 4

An amic acid prepolymer-containing liquid that contains an amic acid prepolymer (0.586 g) and dehydrated DMAc (7.027 g) shown in Table 1 was prepared in a 50 mL screw tube in a fume hood. Next, ODA (0.575 g, 2.87 mmol), PACM (0.288 g, 1.37 mmol). and dehydrated DMAc (2.342 g) were charged into a sample bottle and stirred to prepare a diamine solution. Then, the total amount of the diamine solution and PMDA (0.923 g, 4.23 mmol) was added to the amic acid prepolymer-containing liquid and stirred at room temperature for 3 hours to obtain a polyamic acid-containing liquid 4.

### Example 5

An amic acid prepolymer-containing liquid that contains an amic acid prepolymer (0.360 g) and dehydrated DMAc (6.123 g) shown in Table 1 was prepared in a 50 mL screw tube in a fume hood. Next, ODA (0.575 g, 2.87 mmol), PACM (0.400 g, 1.90 mmol), and dehydrated DMAc (3.278 g) were charged into a sample bottle and stirred to prepare a diamine solution. The total amount of the diamine solution and PMDA (1.04 g, 4.77 mmol) was added to the amic acid prepolymer-containing liquid and stirred at room temperature for 24 hours to obtain a polyamic acid-containing liquid 5. [Method for measuring content of polyamic acid, turbidity and the like]

The content of the polyamic acid and the turbidity of the polyamic acid-containing liquid were measured using the following methods. The measurement results are shown in Table 1. In the polyamic acid-containing liquids of examples 1 to 5, solid residues were not recovered through filtration because a precipitate generated during polymerization reactions dissolved.

### (Content of Polyamic Acid ((2) in Table 2))

The content of the polyamic acid was measured according to the following procedure. Each polyamic acid-containing liquid (25° C.) was filtered under pressure using a stainless steel mesh (150 mesh, “stainless steel mesh #150” (material: SUS316, number of meshes: 150, wire diameter: 0.06 mm, mesh opening: 0.109 mm, opening ratio: 41.6%, weave: plain weave), tantore Corporation) to remove solid residues, and a polyamic acid solution was obtained as a filtrate. An amount of 1.5 g (initial mass) of the polyamic acid solution was weighed using a high-precision electronic balance and was added to an aluminum petri dish. The polyamic acid solution added to the aluminum petri dish was heated at 200° C. for 2 hours to volatilize the solvent, and the polyamic acid was dehydrated and ring-closed to obtain a polyimide. A value obtained by weighing the polyimide with a high-precision electronic balance was used as a mass after heating. An NV2 value (% by mass) (nonvolatile content) was obtained by dividing the mass after heating by 1.5 g (initial mass) and multiplying by 100. The content of the polyamic acid was obtained by correcting the obtained value for the amount of water lost through cyclodehydration of the polyamic acid, according to the following formula. The average molecular weight of the diamine was calculated using the molecular weight and mole fraction of each diamine in structures derived from “diamine” included in the polyamic acid. The average molecular weight of the tetracarboxylic dianhydride was calculated using the molecular weight and mole fraction of each tetracarboxylic dianhydride in structures derived from “tetracarboxylic dianhydride” included in the polyamic acid.

$$Content ( \% by mass ) of polyamic acid = NV 2 value \times \{ ( average molecular weight of diamine ) + ( average molecular weight of tetracarboxylic dianhydride ) \} / \{ ( average molecular weight of diamine ) + ( average molecular weight of tetracarboxylic dianhydride ) - molecular weight of water 18.01 \times 2 \}$$

(Content of Component Derived from Amine and Carboxylic Anhydride ((1) in Table))

An NV1 value (% by mass) was determined using the same procedure as the above “content of polyamic acid” except that an unfiltered polyamic acid-containing liquid was heated. In the above formula, the NV1 value (% by mass) was used instead of the NV2 value (% by mass), and the content of a component derived from an amine and a carboxylic anhydride relative to the mass of the polyamic acid-containing liquid was determined using the average molecular weight of the diamine and the average molecular weight of the tetracarboxylic dianhydride in the component derived from the amine and the carboxylic anhydride included in the polyamic acid-containing liquid

### (Mass Ratio of Polyimide ((4) in Table))

The NV2 value (% by mass) obtained above was determined as a mass ratio of a polyimide obtained by heating a filtrate of the polyamic acid-containing liquid relative to the mass of the polyamic acid-containing liquid.

(Content of Component Derived from Amine and Carboxylic Anhydride after Heating ((3) in Table))

The NV1 value (% by mass) obtained above was determined as a mass ratio of a component derived from an amine and a carboxylic anhydride, obtained by heating the polyamic acid-containing liquid, relative to the mass of the polyamic acid-containing liquid.

### (Turbidity)

Turbidity was measured using a transmitted and scattered light method and determined on the basis of a calibration curve using a formazine standard solution. Measurement conditions are as follows.

Measuring device: spectrophotometer “COH400” (NIPPON DENSHOKU INDUSTRIES CO., LTD.)
Light source: tungsten lamp, color temperature 2,500 degrees (absolute temperature)
Cell dimension (optical path length): 10 mm
Light angle to incident light: 90±30° Peak of sensitivity properties: 500 nm
Sample temperature: 25° C.

### (Viscosity)

Viscosity (ninh) was measured using an Ostwald viscometer in a constant temperature chamber KINEMATIC VISCOSITY BATH TV-5S (THOMAS KAGAKU CO., Ltd.). A sample was prepared by dissolving in DMAc in such a manner that the concentration of the polyamic acid was 0.5 g/dL, and flow time was measured at 30° C.

### (Mass Average Molecular Weight)

The mass average molecular weight was obtained by measuring using gel permeation chromatography (GPC) and converting a value using a standard polystyrene calibration curve. The calibration curve was approximated by a cubic equation using five sample sets of standard polystyrene (TSK standard POLYSTYRENE, Tosoh Corporation). Conditions of GPC are as follows.
GPC equipment: high-speed GPC equipment “HLC-8320GPC” (Tosoh Corporation)
Detector: ultraviolet absorption detector “UV-8320” (Tosoh Corporation)
Column: “Gelpack GL-S300MDT-5” (total two pieces) (Showa Denko Materials Co., Ltd.)

$$Eluent : THF / DMF = 1 / 1 ( volume ratio ) + LiBr ( 0.06 mol / L ) + {H}_{3} {PO}_{4} ( 0.06 mol / L )$$

Flow rate: 1 mL/min
Column size: 8 mm I. D.×300 mm
Sample concentration: 5 mg/l mL
Injection volume: 5 μL
Measurement temperature: 40° C.

### <Evaluation of Polyamic Acid-Containing Liquid>

### (Production of Film)

A film was produced using the polyamic acid-containing liquid (varnish) according to the following procedure.

The surface of a commercially available glass substrate was degreased with acetone, and the polyamic acid varnish was applied in such a manner that the thickness of the imidized film was 25 μm using a film applicator with a film thickness adjusting function. The applied varnish was pre-dried using a hot plate at 80° C. for 60 minutes to form a layer of the polyamic acid. Next, the layer of the polyamic acid was heated using an inert gas oven at 350° C. for 1 hour in a nitrogen atmosphere to form a polyimide film 1. The glass substrate on which the film was formed was immersed in warm water for about 15 minutes, and then the film 1 was peeled off from the glass substrate.

A polyimide film 2 was obtained using the same procedure as described above, except that the polyamic acid-containing liquid (varnish) was applied in such a manner that the thickness of the imidized film was 50 μm, and the film 2 was peeled off from the glass substrate.

### (Relative Permittivity and Dielectric Loss Tangent)

The film 1 was cut into a size of 60 mm×60 mm, dried at 125° C. for 1 hour, and measurement was performed quickly. The permittivity properties (permittivity Dk and dielectric loss tangent Df) of the film were measured using a cavity resonator method (TE mode). For the measurement, a compact USB vector network analyzer (“MS46122B”, ANRITSU CORPORATION) was used. Conditions were set at a frequency of 10 GHz and a measurement temperature of 25° C.

### (Film Forming Properties)

After the films 1 and 2 were cut into 140 mm in length and 70 mm in width, the thickness of each film was measured at 15 points (five points in length and three points in width at 20 to 30 mm intervals) using a high-precision digimatic micrometer (“MDH-25 MB”, Mitutoyo Corporation) and evaluated according to the following criteria.
⊚: when application was performed in such a manner that the thickness of the imidized film was 50 μm, variation of the in-plane distribution of the film thickness was within 50 μm±3 μm (that is, the film thickness of all 15 points is from 47 to 53 μm)
o: when application was performed in such a manner that the thickness of the imidized film was 25 μm, variation of the in-plane distribution of the film thickness was within 25 μm±3 μm (that is, the film thickness of all 15 points is from 22 to 28 μm)
×: when application was performed in such a manner that the thickness of the imidized film was 25 μm, variation of the in-plane distribution of the film thickness was larger than 25 μm±3 μm (that is, the film thickness at one or more points is less than 22 μm or more than 28 μm.)

TABLE 1

| | | | | Example 1 | | Example 2 | | Example 3 | |
|---|---|---|---|---|---|---|---|---|---|
| | | | | Mass (g) or | Monomer | Mass (g) or | Monomer | Mass (g) or | Monomer |
| | | | | concentration | ratio | concentration | ratio | concentration | ratio |
| | | | | (mass %) | (mass %) | (mass %) | (mass %) | (mass %) | (mass %) |
| Step R1 | Amic acid | Aromatic | PMDA | 0.586 | 24.8% | — | — | — | — |
| or | prepolymer- | prepolymer | ODA | | | | | | |
| Step L1 | containing | (Acid dihydride) | (PMDA) | 0.306 | 12.9% | — | — | — | — |
| | liquid | (Aromatic diamine) | (ODA) | 0.280 | 11.9% | — | — | — | — |
| | | Aliphatic or alicyclic | PMDA | — | — | 0.588 | 25.0% | 0.588 | 25.0% |
| | | prepolymer | PACM | | | | | | |
| | | (Acid dihydride) | (PMDA) | — | — | 0.299 | 12.7% | 0.299 | 12.7% |
| | | (Aliphatic or alicyclic | (PACM) | — | — | 0.289 | 12.3% | 0.289 | 12.3% |
| | | diamine) | | | | | | | |
| | | Solvent | DMAc | 4.696 | — | 4.694 | — | 4.694 | — |
| | | Concentration (mass %) | | 11.1% | — | 10.0% | — | 10.0% | — |
| Step R2 | Acid dihydride | | PMDA | 0.910 | 38.5% | 0.900 | 38.3% | 0.900 | 38.3% |
| or | Diamine | Aromatic | ODA | 0.295 | 12.5% | — | — | — | — |
| Step L2 | solution | aliphatic or alicyclic | PACM | 0.575 | 24.3% | 0.863 | 36.7% | 0.863 | 36.7% |
| | | Solvent | DMAc | 4.683 | — | 4.683 | — | 4.683 | — |

| | | | | | | |
|---|---|---|---|---|---|---|
| Concentration (mass %) | 15.7% | — | 15.6% | — | 15.6% | — |

| | | | |
|---|---|---|---|
| Number of additions | One time | One time | *1 |

| Steps R1 + R2 | Aliphatic or alicyclic | 50%/50% | 100%/0% | 100%/0% |
|---|---|---|---|---|
| or | diamine/Aromatic diamine | | | |
| Steps L1 + L2 | Concentration (mass %) | 20.1% | 20.0% | 20.0% |
| Precipitate (salt) | Dissoltion time (hr) | 24 | 8 | 8 |
| Polyamic acid-containing | (1) and (2) (mass %) | 20.0% or more | 20.0% or more | 20.0% or more |
| liquid | (3) and (4) (mass %) | 18.0% or more | 18.0% or more | 18.0% or more |
| | Turbidity (NTU) | 0 | 0 | 0 |
| | Viscosity (dL/g) | 0.42 | 0.38 | 0.41 |
| Polyimide | Permittivity (Dk) | 2.97 | 2.66 | 2.66 |
| | Dielectric loss tangent (Df) | 0.0023 | 0.0023 | 0.0023 |
| | Film forming properties | ◯ | ◯ | ◯ |

| | | | | Example 4 | | Example 5 | |
|---|---|---|---|---|---|---|---|
| | | | | Mass (g) or | Monomer | Mass (g) or | Monomer |
| | | | | concentration | ratio | concentration | ratio |
| | | | | (mass %) | (mass %) | (mass %) | (mass %) |
| Step R1 | Amic acid | Aromatic | PMDA | — | — | — | — |
| or | prepolymer- | prepolymer | ODA | | | | |
| Step L1 | containing | (Acid dihydride) | (PMDA) | — | — | — | — |
| | liquid | (Aromatic diamine) | (ODA) | — | — | — | — |
| | | Aliphatic or alicyclic | PMDA | 0.586 | 24.7% | 0.360 | 15.2% |
| | | prepolymer | PACM | | | | |
| | | (Acid dihydride) | (PMDA) | 0.298 | 12.6% | 0.183 | 7.7% |
| | | (Aliphatic or alicyclic | (PACM) | 0.288 | 12.1% | 0.177 | 7.4% |
| | | diamine) | | | | | |
| | | Solvent | DMAc | 7.027 | — | 6.123 | — |
| | | Concentration (mass %) | | 7.1% | — | 5.3% | — |
| Step R2 | Acid dihydride | | PMDA | 0.923 | 38.9% | 1.040 | 43.8% |
| or | Diamine | Aromatic | ODA | 0.575 | 24.2% | 0.575 | 24.2% |
| Step L2 | solution | aliphatic or alicyclic | PACM | 0.288 | 12.1% | 0.400 | 16.8% |
| | | Solvent | DMAc | 2.342 | — | 3.278 | — |

| | | | | |
|---|---|---|---|---|
| Concentration (mass %) | 26.9% | — | 22.9% | — |

| | | |
|---|---|---|
| Number of additions | One time | One time |

| Steps R1 + R2 | Aliphatic or alicyclic | 50%/50% | 50%/50% |
|---|---|---|---|
| or | diamine/Aromatic diamine | | |
| Steps L1 + L2 | Concentration (mass %) | 20.2% | 20.2% |
| Precipitate (salt) | Dissoltion time (hr) | 3 | 24 |
| Polyamic acid-containing | (1) and (2) (mass %) | 20.0% or more | 20.0% or more |
| liquid | (3) and (4) (mass %) | 18.0% or more | 18.0% or more |
| | Turbidity (NTU) | 0 | 0 |
| | Viscosity (dL/g) | 0.69 | 0.68 |
| Polyimide | Permittivity (Dk) | 2.98 | 2.96 |

| | | |
|---|---|---|
| Dielectric loss tangent (Df) | 0.0024 | 0.0023 |
| Film forming properties | ◯ | ◯ |

*1: Acid dihydride: 4 times in total at 10 minute intervals; Diamine solution: 4 times in total at 10 minute intervals

### (Preparation and Evaluation of Polyamic Acid-Containing Liquid (2))

A polyamic acid-containing liquid was prepared using the production method Ri or the production method Li and was evaluated.

### Example 6

ODA (0.575 g, 2.87 mmol), PMDA (0.586 g, 2.67 mmol), and dehydrated DMAc (7.025 g) were charged into a 50 mL screw tube in a fume hood and stirred for 1 hour. Separately, PACM (0.575 g, 2.73 mmol) and dehydrated DMAc (2.342 g) were charged into a sample bottle and stirred to prepare a diamine solution. Then, the total amount of the diamine solution and PMDA (0.637 g, 2.92 mmol) was charged into the screw tube and stirred at room temperature for 24 hours in total to obtain a polyamic acid-containing liquid 6.

### Example 7

ODA (0.626 g, 3.13 mmol), PMDA (0.634 g, 2.91 mmol), and dehydrated DMAc (9.366 g) were charged into a 50 mL screw tube in a fume hood and stirred for 1 hour. Separately, NBDA (0.626 g, 4.06 mmol) and dehydrated DMAc (1.873 g) were charged into a sample bottle and stirred to prepare a diamine solution. Then, the total amount of the diamine solution and PMDA (0.933 g, 4.28 mmol) was charged into the screw tube and stirred at room temperature for 8 hours in total to obtain a polyamic acid-containing liquid 7.

### Example 8

ODA (0.870 g, 4.34 mmol), PMDA (0.220 g, 1.01 mmol), and dehydrated DMAc (7.025 g) were charged into a 50 mL screw tube in a fume hood and stirred for 1 hour. Separately, DDA (0.378 g, 0.71 mmol) and dehydrated DMAc (2.342 g) were charged into a sample bottle and stirred to prepare a diamine solution. Then, the total amount of the diamine solution and PMDA (0.881 g, 4.04 mmol) was charged into the screw tube and stirred at room temperature for 8 hours in total to obtain a polyamic acid-containing liquid 8.

### Example 9

ODA (0.703 g, 3.51 mmol), PMDA (0.204 g, 0.94 mmol), and dehydrated DMAc (7.025 g) were charged into a 50 mL screw tube in a fume hood and stirred for 1 hour. Separately, DDA (0.626 g, 1.17 mmol) and dehydrated DMAc (2.342 g) were charged into a sample bottle and stirred to prepare a diamine solution. Then, the total amount of the diamine solution and PMDA (0.817 g, 3.74 mmol) was charged into the screw tube and stirred at room temperature for 3 hours in total to obtain a polyamic acid-containing liquid 9.

### Example 10

ODA (0.402 g, 2.01 mmol), PMDA (0.175 g, 0.80 mmol), and dehydrated DMAc (7.025 g) were charged into a 50 mL screw tube in a fume hood and stirred for 1 hour. Separately, DDA (1.073 g, 2.01 mmol) and dehydrated DMAc (2.342 g) were charged into a sample bottle and stirred to prepare a diamine solution. Then, the total amount of the diamine solution and PMDA (0.700 g, 3.21 mmol) was charged into the screw tube and stirred at room temperature for 3 hours in total to obtain a polyamic acid-containing liquid 10.

### Example 11

ODA (0.288 g, 1.44 mmol), PACM (0.288 g, 1.37 mmol), PMDA (0.613 g, 2.81 mmol), and dehydrated DMAc (8.429 g) were charged into a 50 mL screw tube in a fume hood and stirred for 1 hour. Separately, PACM (0.288 g, 1.37 mmol) and dehydrated DMAc (0.937 g) were charged into a sample bottle and stirred to prepare a diamine solution. Then, the total amount of the diamine solution, ODA (0.288 g, 1.44 mmol), and PMDA (0.610 g, 2.80 mmol) was charged into the screw tube and stirred at room temperature for 8 hours in total to obtain a polyamic acid-containing liquid 11.

### Example 12

PACM (0.575 g, 2.73 mmol), PMDA (0.596 g, 2.73 mmol), and dehydrated DMAc (9.366 g) were charged into a 50 mL screw tube in a fume hood and stirred for 1 hour. Next, the total amount of ODA (0.575 g, 2.87 mmol) and PMDA (0.627 g, 2.87 mmol) was charged into the screw tube and stirred at room temperature for 3 hours in total to obtain a polyamic acid-containing liquid 12.

### Example 13

PACM (0.575 g, 2.73 mmol), PMDA (0.596 g, 2.73 mmol), and dehydrated DMAc (8.429 g) were charged into a 50 mL screw tube in a fume hood and stirred for 1 hour. Separately, PACM (0.288 g, 1.37 mmol) and dehydrated DMAc (0.937 g) were charged into a sample bottle and stirred to prepare a diamine solution. Then, the total amount of the diamine solution, ODA (0.288 g, 1.44 mmol), and PMDA (0.627 g, 2.87 mmol) was charged into the screw tube and stirred at room temperature for 8 hours in total to obtain a polyamic acid-containing liquid 13.

### Example 14

PACM (0.577 g, 2.74 mmol), PMDA (0.598 g, 2.74 mmol), and dehydrated DMAc (8.429 g) were charged into a 50 mL screw tube in a fume hood and stirred for 1 hour. Separately, PACM (0.577 g, 2.74 mmol) and DMAc (0.937 g) were charged into a sample bottle and stirred to prepare a diamine solution. Then, the total amount of the diamine solution and PMDA (0.637 g, 2.92 mmol) was charged into the screw tube and stirred at room temperature for 8 hours in total to obtain a polyamic acid-containing liquid 14.

### Example 15

PACM (0.288 g, 1.37 mmol) and dehydrated DMAc (4.683 g) were charged into a 50 mL screw tube in a fume hood and stirred to prepare a diamine solution 1. Then, PMDA (0.300 g, 1.37 mmol) was added to the diamine solution 1 and stirred for 10 minutes. Separately, PACM (0.863 g, 4.10 mmol) and dehydrated DMAc (4.683 g) were charged into a sample bottle and stirred to prepare a diamine solution 2. Then, PMDA (0.900 g, 4.10 mmol) and the diamine solution 2 were each divided into three equal portions and added one after another into the screw tube one portion at a time every 10 minutes while stirring, and stirred at room temperature for 8 hours in total to obtain a polyamic acid-containing liquid 15. The stirring time is the time from the first addition to the end of stirring.

### Example 16

NBDA (0.575 g, 3.73 mmol), PMDA (0.586 g, 2.69 mmol), and dehydrated DMAc (8.429 g) were charged into a 50 mL screw tube in a fume hood and stirred for 1 hour. Separately, PACM (0.575 g, 2.73 mmol) and dehydrated DMAc (0.937 g) were charged into a sample bottle to prepare a diamine solution. Then, the diamine solution and PMDA (0.637 g, 2.92 mmol) were divided into two portions and three portions, respectively. The portions of each set were added into the screw tube one after another every 10 minutes, totaling two times for the diamine solution, and three times for PMDA, and stirred at room temperature for 8 hours in total to obtain a polyamic acid solution 16. The diamine solution was divided into two equal portions. PMDA was divided into three portions at a ratio of 5:4:1.

### Comparative Example 1

PACM (1.151 g, 5.47 mmol) and dehydrated DMAc (9.366 g) were charged into a 50 mL screw tube in a fume hood to prepare a diamine solution. Then, PMDA (1.195 g, 5.48 mmol) was divided in four portions, one of which was added every 10 minutes. After the addition, the mixture was stirred at room temperature for 24 hours in total to obtain a polyamic acid-containing liquid.

### Comparative Example 2

PACM (0.342 g, 1.62 mmol) and dehydrated DMAc (9.366 g) were charged into a 50 mL screw tube in a fume hood to prepare a diamine solution. Then, the total amount of ODA (0.797 g, 3.98 mmol) and PMDA (1.221 g, 5.60 mmol) was added. After the addition, the mixture was stirred at room temperature for 24 hours in total to obtain a polyamic acid-containing liquid.

### [Method for Measuring Content of Polyamic Acid, Turbidity, and the Like]

Measurement was performed in the same manner as in the preparation and evaluation of the polyamic acid-containing liquid (1). Measurement results are shown in Tables 2-1 to 2-3. In the polyamic acid-containing liquids of examples 6 to 16, solid residues were not recovered through filtration because a precipitate generated during polymerization reactions dissolved.

### <Evaluation of Polyamic Acid-Containing Liquid>

Evaluation was performed in the same manner as in the preparation and evaluation of the polyamic acid-containing liquid (1). Evaluation results are shown in Table 2. Note that in comparative examples 1 and 2, films could not be produced using polyamic acid-containing liquids.

TABLE 2-1

| | | | | Example 6 | | Example 7 | | Example 8 | |
|---|---|---|---|---|---|---|---|---|---|
| | | | | Mass (g) or | Monomer | Mass (g) or | Monomer | Mass (g) or | Monomer |
| | | | | concentration | ratio | concentration | ratio | concentration | ratio |
| | | | | (mass %) | (mass %) | (mass %) | (mass %) | (mass %) | (mass %) |
| Step R1 | Acid dihydride | | PMDA | 0.586 | 24.7% | 0.634 | 22.5% | 0.220 | 9.4% |
| | Diamine | Aromatic | ODA | 0.575 | 24.2% | 0.626 | 22.2% | 0.870 | 37.0% |
| | | Aliphatic or | PACM | — | — | — | — | — | — |
| | | alicyclic | NBDA | — | — | — | — | — | — |
| | Solvent | | DMAc | 7.025 | — | 9.366 | — | 7.025 | — |
| | Concentration (mass %) | | | 14.2% | — | 11.9% | — | 13.4% | — |
| | Mass average molecular weight | | | 6,100 | | 6,400 | | 550 | |
| Step R2 | Acid dihydride | | PMDA | 0.637 | 26.8% | 0.933 | 33.1% | 0.881 | 37.5% |
| | Diamine | Aromatic | ODA | — | — | — | — | — | — |
| | | Aliphatic or | PACM | 0.575 | 24.2% | — | — | — | — |
| | | alicyclic | NBDA | — | — | 0.626 | 22.2% | — | — |
| | | | DDA | — | — | — | — | 0.378 | 16.1% |
| | | Solvent | DMAc | 2.342 | — | 1.873 | — | 2.342 | — |

| | | | | | | |
|---|---|---|---|---|---|---|
| Concentration (mass %) | 19.7% | — | 25.0% | — | 13.9% | — |

| | | | |
|---|---|---|---|
| Number of additions | One time | One time | One time |

| | | | | |
|---|---|---|---|---|
| Steps R1 + R2 | Aliphatic or alicyclic | 50%/50% | 50%/50% | 30%/70% |
| | diamine/Aromatic diamine | | | |
| | Concentration (mass %) | 20.2% | 20.1% | 20.1% |
| Precipitate (salt) | Dissoltion time (hr) | 24 | 8 | 8 |
| Polyamic acid- | (1) and (2) (mass %) | 20.0% or more | 20.0% or more | 20.0% or more |
| containing liquid | (3) and (4) (mass %) | 18.0% or more | 18.0% or more | 18.0% or more |
| | Turbidity (NTU) | 0 | 0 | 0 |
| | Viscosity (dL/g) | 0.79 | 0.58 | 0.76 |
| Polyimide | Permittivity (Dk) | 2.97 | 2.99 | 2.95 |
| | Dielectric loss tangent (Df) | 0.0024 | 0.0039 | 0.0020 |
| | Film forming properties | ◯ | ◯ | ◯ |

| | | | Example 9 | | Example 10 | |
|---|---|---|---|---|---|---|
| | | | Mass (g) or | Monomer | Mass (g) or | Monomer |
| | | | concentration | ratio | concentration | ratio |
| | | | (mass %) | (mass %) | (mass %) | (mass %) |
| Step R1 | Acid dihydride | PMDA | 0.204 | 8.7% | 0.175 | 7.4% |

| | | | | | | |
|---|---|---|---|---|---|---|
| Diamine | Aromatic | ODA | 0.703 | 29.9% | 0.402 | 17.1% |
| | Aliphatic or | PACM | — | — | — | — |
| | alicyclic | NBDA | — | — | — | — |

| | Solvent | DMAc | 7.025 | — | 7.025 | — |
|---|---|---|---|---|---|---|
| | Concentration (mass %) | | 11.4% | — | 7.6% | — |
| | Mass average molecular weight | | 570 | | 700 | |
| Step R2 | Acid dihydride | PMDA | 0.817 | 34.8% | 0.700 | 29.8% |

| | | | | | | |
|---|---|---|---|---|---|---|
| Diamine | Aromatic | ODA | — | — | — | — |
| | Aliphatic or | PACM | — | — | — | — |
| | alicyclic | NBDA | — | — | — | — |
| | | DDA | 0.626 | 26.6% | 1.073 | 45.7% |
| | Solvent | DMAc | 2.342 | — | 2.342 | — |

| | | | | |
|---|---|---|---|---|
| Concentration (mass %) | 21.1% | — | 31.4% | — |

| | | |
|---|---|---|
| Number of additions | One time | One time |

| | | | |
|---|---|---|---|
| Steps R1 + R2 | Aliphatic or alicyclic | 47%/53% | 73%/27% |
| | diamine/Aromatic diamine | | |
| | Concentration (mass %) | 20.1% | 20.1% |
| Precipitate (salt) | Dissoltion time (hr) | 3 | 3 |
| Polyamic acid- | (1) and (2) (mass %) | 20.0% or more | 20.0% or more |
| containing liquid | (3) and (4) (mass %) | 18.0% or more | 18.0% or more |
| | Turbidity (NTU) | 0 | 0 |
| | Viscosity (dL/g) | 0.83 | 0.52 |
| Polyimide | Permittivity (Dk) | 2.86 | 2.66 |
| | Dielectric loss tangent (Df) | 0.0014 | 0.0014 |
| | Film forming properties | ◯ | ◯ |

TABLE 2-2

| | | | | Examle 11 | | Example 12 | | Example 13 | |
|---|---|---|---|---|---|---|---|---|---|
| | | | | Mass (g) or | Monomer | Mass (g) or | Monomer | Mass (g) or | Monomer |
| | | | | concentration | ratio | concentration | ratio | concentration | ratio |
| | | | | (mass %) | (mass %) | (mass %) | (mass %) | (mass %) | (mass %) |
| Step L1 | Acid dihydride | | PMDA | 0.613 | 25.8% | 0.596 | 25.1% | 0.596 | 25.1% |
| | Diamine | Aromatic | ODA | 0.288 | 12.1% | — | — | — | — |
| | | Aliphatic or | PACM | 0.288 | 12.1% | 0.575 | 24.2% | 0.575 | 24.2% |
| | | alicyclic | NBDA | — | — | — | — | — | — |
| | Solvent | | DMAc | 8.429 | — | 9.366 | — | 8.429 | — |
| | Concentration (mass %) | | | 12.4% | — | 11.1% | — | 12.2% | — |
| | Mass average molecular weight | | | 73,500 | | 55,000 | | 37,800 | |
| Step L2 | Acid dihydride | | PMDA | 0.610 | 25.7% | 0.627 | 26.4% | 0.627 | 26.4% |
| | Diamine | Aromatic | ODA | 0.288 | 12.1% | 0.575 | 24.2% | 0.288 | 12.1% |
| | | Aliphatic or | PACM | 0.288 | 12.1% | — | — | 0.288 | 12.1% |
| | | alicyclic | NBDA | — | — | — | — | — | — |
| | | | DDA | — | — | — | — | — | — |
| | | Solvent | DMAc | 0.937 | | — | — | 0.937 | — |
| | | Concentration (mass %) | | 23.5% | — | — | — | 23.5% | — |
| | Number of additions | | | One time | | One time | | One time | |
| Steps L1 + L2 | | Aliphatic or alicyclic | | 50%/50% | | 50%/50% | | 75%/25% | |
| | | diamine/Aromatic diamine | | | | | | | |
| | | Concentration (mass %) | | 20.2% | | 20.2% | | 20.2% | |
| Precipitate (salt) | | Dissoltion time (hr) | | 8 | | 8 | | 8 | |
| Polyamic acid- | | (1) and (2) (mass %) | | 20.0% or more | | 20.0% or more | | 20.0% or more | |
| containing liquid | | (3) and (4) (mass %) | | 18.0% or more | | 18.0% or more | | 18.0% or more | |
| | | Turbidity (NTU) | | 0 | | 0 | | 0 | |
| | | Viscosity (dL/g) | | 0.61 | | 0.61 | | 0.57 | |
| Polyimide | | Permittivity (Dk) | | 2.99 | | 2.98 | | 2.72 | |
| | | Dielectric loss tangent (Df) | | 0.0023 | | 0.0024 | | 0.0025 | |
| | | Film forming properties | | ◯ | | ◯ | | ◯ | |
| | | | | Example 14 | | Example 15 | | Example 16 | |
| | | | | Mass (g) or | Monomer | Mass (g) or | Monomer | Mass (g) or | Monomer |
| | | | | concentration | ratio | concentration | ratio | concentration | ratio |
| | | | | (mass %) | (mass %) | (mass %) | (mass %) | (mass %) | (mass %) |
| Step L1 | Acid dihydride | | PMDA | 0.598 | 25.0% | 0.300 | 12.8% | 0.586 | 24.7% |
| | Diamine | Aromatic | ODA | — | — | — | — | — | — |
| | | Aliphatic or | PACM | 0.577 | 24.2% | 0.288 | 12.3% | — | — |
| | | alicyclic | NBDA | — | — | — | — | 0.575 | 24.2% |
| | Solvent | | DMAc | 8.429 | — | 4.683 | | 8.429 | — |
| | Concentration (mass %) | | | 12.2% | — | 11.2% | | 12.1% | — |
| | Mass average molecular weight | | | 47,600 | | 55,000 | | 36,000 | |
| Step L2 | Acid dihydride | | PMDA | 0.637 | 26.7% | 0.900 | 38.3% | 0.637 | 26.8% |
| | Diamine | Aromatic | ODA | — | — | — | — | — | — |
| | | Aliphatic or | PACM | 0.577 | 24.2% | 0.863 | 36.7% | 0.575 | 24.2% |
| | | alicyclic | NBDA | — | — | — | — | — | — |
| | | | DDA | — | — | — | — | — | — |
| | | Solvent | DMAc | 0.937 | — | 4.683 | — | 0.937 | — |

| | | | | | | |
|---|---|---|---|---|---|---|
| Concentration (mass %) | 38.1% | — | 15.6% | — | 38.0% | — |

| | | | |
|---|---|---|---|
| Number of additions | One time | *1 | *2 |

| Steps L1 + L2 | Aliphatic or alicyclic | 100%/0% | 100%/0% | 50%/50% |
|---|---|---|---|---|
| | diamine/Aromatic diamine | | | |
| | Concentration (mass %) | 20.3% | 20.1% | 20.2% |
| Precipitate (salt) | Dissoltion time (hr) | 8 | 8 | 8 |
| Polyamic acid- | (1) and (2) (mass %) | 20.0% or more | 20.0% or more | 20.0% or more |
| containing liquid | (3) and (4) (mass %) | 18.0% or more | 18.0% or more | 18.0% or more |
| | Turbidity (NTU) | 0 | 0 | 0 |
| | Viscosity (dL/g) | 0.35 | 0.55 | 0.41 |
| Polyimide | Permittivity (Dk) | 2.66 | 2.66 | 2.67 |
| | Dielectric loss tangent (Df) | 0.0023 | 0.0023 | 0.0053 |
| | Film forming properties | ◯ | ◯ | ◯ |

*1: Acid dihydride: 3 times in total at 10 minute intervals; Diamine solution: 3 times in total at 10 minute intervals
*2: Acid dihydride: 3 times in total at 10 minute intervals; Diamine solution: 2 times in total at 10 minute intervals

TABLE 2-3

| | | | | Comparative example 1 | | Comparative example 2 | |
|---|---|---|---|---|---|---|---|
| | | | | Mass (g) or | Monomer | Mass (g) or | Monomer |
| | | | | concentration | ratio | concentration | ratio |
| | | | | (mass %) | (mass %) | (mass %) | (mass %) |
| Step R1 | Acid dihydride | | PMDA | 1.195 | 51.0% | 1.221 | 51.8% |
| or | Diamine | Aromatic | ODA | — | — | 0.797 | 33.8% |
| Step L1 | | Aliphatic or | PACM | 1.151 | 49.0% | 0.342 | 14.5% |
| | | alicyclic | NBDA | — | — | — | — |
| | Solvent | | DMAc | 9.366 | — | 9.366 | — |
| | Concentration (mass %) | | | 20.0% | — | 20.1% | — |
| | Number of addition | | | *1 | | One time | |
| Step R2 | Acid dihydride | | PMDA | — | — | — | — |
| or | Diamine | Aromatic | ODA | — | — | — | — |
| Step L2 | | Aliphatic or | PACM | — | — | — | — |
| | | alicyclic | NBDA | — | — | — | — |
| | | | DDA | — | — | — | — |
| | | Solvent | DMAc | — | — | — | — |

| | Concentration (mass %) | — | — | — | — |
|---|---|---|---|---|---|
| Steps R1 + R2 | Aliphatic or alicyclic | 100%/0% | | 30%/70% | |
| or | diamine/Aromatic diamine | | | | |

| | | | |
|---|---|---|---|
| Steps L1 + L2 | Concentration (mass %) | 20.0% | 20.1% |

| Precipitate (salt) | Dissoltion time (hr) | Precipitate remains | Precipitate remains |
|---|---|---|---|
| | | after 24 hours | after 24 hours |
| Polyamic acid- | (1) (mass %) | 20.0% or more | 20.0% or more |
| containing liquid | (2) (mass %) | 12.1% | 17.4% |
| | (3) (mass %) | 18.0% or more | 18.0% or more |
| | (4) (mass %) | 11.1% | 16.0% |
| | Turbidity (NTU) | 17 | 2.8 |
| | Viscosity (dL/g) | 0.62 | 0.70 |
| Polyimide | Permittivity (Dk) | No film formation | No film formation |
| | Dielectric loss tangent (Df) | | |
| | Film forming properties | | |

*1: Acid dihydride: 4 times in total at 10 minute intervals; Diamine solution: one time

### <Preparation and Evaluation of Polyamic Acid-Containing Liquid (3)>

### Example 17

### (Preparation of Polyamic Acid-Containing Liquid 17a)

A polyamic acid-containing liquid 17a was prepared using the manufacturing method Ri.

ODA (24.5 g, 0.122 mol), PMDA (7.11 g, 0.033 mol), and dehydrated DMAc (300.0 g) were charged into a 500 mL three-neck flask in a fume hood and stirred for 1 hour. Separately, DDA (21.8 g, 0.041 mol) and dehydrated DMAc (20.0 g) were charged into a sample bottle and stirred to prepare a diamine solution a. Then, the total amount of the diamine solution a and PMDA (26.6 g, 0.122 mol) was charged into the screw tube and stirred at room temperature for 8 hours in total to obtain a polyamic acid-containing liquid 17a.

### (Preparation of Polyamic Acid-Containing Liquid 17b)

Using the polyamic acid-containing liquid 17a as an aromatic prepolymer-containing liquid, a polyamic acid-containing liquid 17b was prepared according to the production method Rs.

ODA (10.2 g, 0.051 mol) and PMDA (2.97 g, 0.014 mol) were charged into a 500 mL three-neck flask containing the polyamic acid-containing liquid 17a and stirred for 1 hour. Separately, DDA (9.10 g, 0.017 mol) and dehydrated DMAc (18.2 g) were charged into a sample bottle and stirred to prepare a diamine solution b. Then, the total amount of the diamine solution b and PMDA (11.1 g, 0.051 mol) were charged into the screw tube and stirred at room temperature for 8 hours in total to obtain the polyamic acid-containing liquid 17b.

### [Method for Measuring Content of Polyamic Acid, Turbidity, and the Like]

Measurement was performed in the same manner as in the preparation and evaluation of the polyamic acid-containing liquid (1), except that viscosity was measured using the following method. Measurement results are shown in Table 3. In the polyamic acid-containing liquid of example 17, a solid residue was not recovered through filtration because a precipitate generated during the polymerization reaction dissolved.

### (Viscosity)

The viscosity was measured using a rotary type B viscometer (TVB-10M, Toki Sangyo Co., Ltd) using a No. 3 rotor with the temperature of the polyamic acid-containing liquid set at 30° C.

### <Evaluation of Polyamic Acid-Containing Liquid>

Evaluation was performed in the same manner as the preparation and evaluation of the polyamic acid-containing liquid (1). Evaluation results are shown in Table 3.

TABLE 3

| | | | | Example 17 | |
|---|---|---|---|---|---|
| | | | | Mass (g) or | Monomer |
| | | | | concentration | ratio |
| | | | | (mass %) | (mass %) |
| Step R1 | Amic acid | Aromatic | PMDA | 80.0 | 70.5% |
| | prepolymer- | prepolymer | ODA | | |
| | containing | (Acid dihydride) | (PMDA) | 33.8 | 29.8% |
| | liquid | (Aromatic diamine) | (ODA) | 24.5 | 21.6% |
| | | (Aliphatic or | (DDA) | 21.8 | 19.2% |
| | | alicyclic prepolymer) | | | |
| | | Solvent | DMAc | 320.0 | — |
| | | Concentration (mass %) | | 20.0% | — |
| Step R2 | Acid dihydride | | PMDA | 14.1 | 12.4% |
| | Diamine | Aromatic | ODA | 10.2 | 9.0% |
| | | Aliphatic or | DDA | 9.1 | 8.0% |
| | | alicyclic | | | |
| | | Solvent | DMAc | 18.2 | — |

| | | |
|---|---|---|
| Concentration (mass %) | 33.3% | — |

| | |
|---|---|
| Number of additions | *1 |

| Steps R1 + R2 | Aliphatic or alicyclic | 50%/50% |
|---|---|---|
| | diamine/Aromatic diamine | |
| | Concentration (mass %) | 25.1% |
| Precipitate (salt) | Dissoltion time (hr) | 8 |
| Polyamic acid- | (1) and (2) (mass %) | 25.0% or more |
| containing liquid | (3) and (4) (mass %) | 22.5% or more |
| | Turbidity (NTU) | 0 |
| | Viscosity (Pa · s) | 8.5 |
| Polyimide | Permittivity (Dk) | 2.84 |
| | Dielectric loss tangent (Df) | 0.00121 |
| | Film forming properties | ⊚ |

*1: Acid dihydride: 2 times in total at 1 hour interval; Diamine solution: 2 times in total at 1 hour interval

1. A method for producing a polyamic acid-containing liquid comprising:
obtaining a polyamic acid-containing liquid that contains a polyamic acid, by using a prepolymer-containing liquid that contains an amic acid prepolymer including a structure derived from an aromatic diamine and a structure derived from a tetracarboxylic dianhydride, an aliphatic or alicyclic diamine, and a tetracarboxylic dianhydride.

2. The method for producing a polyamic acid-containing liquid according to claim 1, comprising:
obtaining the prepolymer-containing liquid by using an aromatic diamine, a tetracarboxylic dianhydride, and a solvent; and
obtaining the polyamic acid-containing liquid by adding the aliphatic or alicyclic diamine and the tetracarboxylic dianhydride to the prepolymer-containing liquid.

3. The method for producing a polyamic acid-containing liquid according to claim 1, comprising adding one or both of the aliphatic or alicyclic diamine and the tetracarboxylic dianhydride to the prepolymer-containing liquid in two or more portions.

4. The method for producing a polyamic acid-containing liquid according to claim 1, wherein a content of the amic acid prepolymer in the prepolymer-containing liquid is 30.0% by mass or less.

5. The method for producing a polyamic acid-containing liquid according to claim 1, wherein a mass ratio of the amic acid prepolymer relative to a mass of the polyamic acid is 10.0% by mass or more.

6. The method for producing a polyamic acid-containing liquid according to claim 1, wherein a content of the amic acid prepolymer in the prepolymer-containing liquid is 15.0% by mass or more, and a mass of the amic acid prepolymer relative to a mass of the polyamic acid is 50.0% by mass or more.

7. The method for producing a polyamic acid-containing liquid according to claim 1, wherein the amic acid prepolymer further includes a structure derived from an aliphatic or alicyclic diamine.

8. A method for producing a polyamic acid-containing liquid comprising:
obtaining a polyamic acid-containing liquid that contains a polyamic acid, by using a prepolymer-containing liquid that contains an amic acid prepolymer including a structure derived from an aliphatic or alicyclic diamine and a structure derived from a tetracarboxylic dianhydride, a diamine, and a tetracarboxylic dianhydride.

9. The method for producing a polyamic acid-containing liquid according to claim 8, comprising:
obtaining the prepolymer-containing liquid by using an aliphatic or alicyclic diamine, a tetracarboxylic dianhydride, and a solvent; and
obtaining the polyamic acid-containing liquid by adding the diamine and the tetracarboxylic dianhydride to the prepolymer-containing liquid.

10. The method for producing a polyamic acid-containing liquid according to claim 8, comprising adding one or both of the diamine and the tetracarboxylic dianhydride to the prepolymer-containing liquid in two or more portions.

11. The method for producing a polyamic acid-containing liquid according to claim 8, wherein a content of the amic acid prepolymer in the prepolymer-containing liquid is 15.0% by mass or less.

12. The method for producing a polyamic acid-containing liquid according to claim 8, wherein a mass ratio of the amic acid prepolymer relative to a mass of the polyamic acid is 10.0% by mass or more.

13. The method for producing a polyamic acid-containing liquid according to claim 8, wherein the amic acid prepolymer further includes a structure derived from an aromatic diamine.

14. A polyamic acid-containing liquid comprising: a polyamic acid including a structure derived from an aliphatic or alicyclic diamine and a structure derived from a tetracarboxylic dianhydride, and a solvent; and
satisfying one or both of (1) and (2) below:
(1) a content of a component derived from an amine and a carboxylic anhydride is 20.0% by mass or more; and a turbidity is 2.5 NTU or less; and
(2) a content of the polyamic acid is 20.0% by mass or more relative to a total mass of the polyamic acid and the solvent.

15. The polyamic acid-containing liquid according to claim 14, satisfying the above (1).

16. The polyamic acid-containing liquid according to claim 14, satisfying the above (2).

17. A polyamic acid-containing liquid comprising: a polyamic acid including a structure derived from an aliphatic or alicyclic diamine and a structure derived from a tetracarboxylic dianhydride, and a solvent; and
satisfying one or both of (3) and (4) below:
(3) a turbidity is 2.5 NTU or less; and a mass ratio of a component derived from an amine and a carboxylic anhydride, obtained by heating the polyamic acid-containing liquid, relative to a mass of the polyamic acid-containing liquid is 18.0% by mass or more; and
(4) a mass ratio of a polyimide obtained by heating a filtrate of the polyamic acid-containing liquid, relative to a mass of the polyamic acid-containing liquid is 18.0% by mass or more.

18. The polyamic acid-containing liquid according to claim 17, satisfying the above (3).

19. The polyamic acid-containing liquid according to claim 17, satisfying the above (4).

20. The polyamic acid-containing liquid according to claim 14, wherein the structure derived from a tetracarboxylic dianhydride includes a structure derived from a pyromellitic dianhydride.

21. The polyamic acid-containing liquid according to claim 14, wherein the polyamic acid further includes a structure derived from an aromatic diamine.

22. The polyamic acid-containing liquid according to claim 14, wherein a content of the structure derived from an aliphatic or alicyclic diamine is 20% by mass or more relative to a total mass of a structure derived from a diamine included in the polyamic acid.

23. The polyamic acid-containing liquid according to claim 20, wherein a content of the structure derived from a pyromellitic dianhydride is 50% by mass or more relative to a total mass of a structure derived from a tetracarboxylic dianhydride included in the polyamic acid.

24. The polyamic acid-containing liquid according to claim 20, wherein
a content of the structure derived from an aliphatic or alicyclic diamine is 20% by mass or more relative to a total mass of a structure derived from a diamine included in the polyamic acid, and
a content of the structure derived from a pyromellitic dianhydride is 50% by mass or more relative to a total mass of a structure derived from a tetracarboxylic dianhydride included in the polyamic acid.

25. The polyamic acid-containing liquid according to claim 14, wherein the structure derived from an aliphatic or alicyclic diamine includes a structure derived from an alicyclic diamine.

26. The polyamic acid-containing liquid according to claim 14, wherein the structure derived from an aliphatic or alicyclic diamine includes a structure derived from a dimer diamine.

27. The polyamic acid-containing liquid according to claim 14, wherein the polyamic acid-containing liquid is for a printed board use.

28. A method for producing a polyimide comprising obtaining a polyimide by using the polyamic acid-containing liquid according to claim 14.

29. A method for producing a compact comprising obtaining a compact by using the polyamic acid-containing liquid according to claim 14.

30. A method for producing a printed board comprising obtaining a printed board by using the polyamic acid-containing liquid according to claim 14.
